(19) United States
(12) Patent Application Publication
(10) Pub. No.: US 2005/0190805 A1
(43) Pub. Date: Sep. 1, 2005

(54) Doped stoichiometric lithium niobate and lithium tantalate for self-frequency conversion lasers

(76) Inventors: Michael P. Scripsick, Florham Park, NJ (US); Barry A. Wechsler, Kinnelon, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/877,805

(22) Filed: Jun. 24, 2004

Related U.S. Application Data
(60) Provisional application No. 60/483,494, filed on Jun. 30, 2003.

(51) Int. Cl. H01S 3/16

(52) U.S. Cl. 372/41; 372/68

(57) ABSTRACT

In accordance with the present invention, a crystal laser material that is suitable for self doubling is presented. A crystal according to the present invention includes a stoichiometric lithium niobate crystal isomorph host material doped with at least one laser ion. In some embodiments, the stoichiometric lithium niobate crystal isomorph host material is lithium niobate. In some embodiments, the stoichiometric lithium niobate crystal isomorph host material is lithium tantalate. In some embodiments, the at least one laser ion includes Ytterbium. In some embodiments, the at least one laser ion includes a rare-earth ion. In some embodiments, the stoichiometric lithium niobate crystal isomorph host material is periodically poled to provide quasi-phase matching. Additionally, further dopant ions, for example Magnesium, can be included.

### RELATED APPLICATIONS

The present application claims priority to a U.S. provisional patent application No. 60/483,494, filed on or about Jun. 24, 2003, which is herein incorporated by reference in its entirety.

### GOVERNMENT FUNDING

Aspects of the present invention were developed under a grant from the National Science Foundation, Grant # DMI-0215211. As such, certain rights in the present invention are retained by the U.S. Government.

### BACKGROUND

1. Field of the Invention

The present invention is related to laser materials and, in particular, to a stoichiometric lithium niobate crystal isomorph host doped with at least one laser ion.

2. Discussion of Related Art

Solid state lasers are used in a wide variety of commercial and military applications such as entertainment and projection systems, optical communications, optical data storage, medical and surgical treatments, industrial machining, scientific spectroscopy, target designation and tracking, missile and ordinance countermeasures, and standoff detection of chemical and biological agents. Each specific application requires the use of specific wavelengths of laser light ranging from the ultraviolet to the infrared regimes. In some applications, appropriate wavelengths of laser light are either unavailable or difficult and expensive to obtain.

A laser operates with a fundamental wavelength determined by the discrete energy levels of a lasing ion within a host medium. One such solid state laser system employs neodymium (Nd³⁺) doped into yttrium aluminum garnet (Y₃Al₅O₁₂ or YAG) crystals. When pumped with light from a flashlamp or diode laser within the absorption band of Nd³⁺, the doped crystal emits strongly at a wavelength of 1064 nm and more weakly at wavelengths of 1320 nm and 946 nm. With appropriate design of laser resonator cavities, Nd:YAG lasers operating at each of these wavelengths can be produced. The most common commercially available Nd:YAG lasers operate at a wavelength of 1064 nm due to the higher efficiency and simpler cavity designs resulting from the much stronger emission at this wavelength. While solid state lasers that employ other lasing ions and/or host crystals have been demonstrated, their outputs are similarly restricted to a few wavelengths corresponding to their strongest emission peaks. As a result of the limited number of lasing ions and host crystals, the limited availability of appropriate excitation sources, and the complexity of resonator designs required to achieve efficient lasing, only a handful of wavelengths are thereby produced by commercially available solid state lasers.

For applications requiring laser radiation at wavelengths not included in the wavelengths commonly produced by the relatively small number of these primary laser sources, a nonlinear optical (NLO) crystal is often used to convert the laser output radiation to radiation of the desired wavelength. Converting light of one wavelength to another (or equivalently from one frequency to another) via NLO frequency conversion is constrained by conservation of energy, which requires that the combined energy of the initial light produced by the laser source is equivalent to the combined energy of the resultant light after passing through the non-linear optical material. In a multi-wavelength laser source, the constraints produced by conservation of energy can be expressed as:
1/λᵢ₁+1/λᵢ₂+ . . . =1/λᵣ₁+1/λᵣ₂+ . . . ,
where the subscripts “i” and “r” refer to the initial light and resultant light, respectively.

Second harmonic generation (SHG), also called frequency doubling, is one example of a NLO frequency conversion process wherein two photons of initial light are combined into one photon of resultant light with frequency twice that of the initial photons (or equivalently with wavelength one half that of the initial photons). A common example of second harmonic generation is the conversion of laser light in the near infrared spectral region at 1064 nm from a Nd:YAG laser source to visible green laser light at 532 nm wavelength by using the NLO crystals KTiOPO₄ (KTP) or LiB₃O₅ (LBO).

In the NLO conversion process, energy can flow in both directions (initial beam to resultant beam or from resultant beam to initial beam). The direction of energy flow within a NLO medium is dependent on the relative phase of the two light beams. Since light of different wavelengths typically travel at different speeds through an optical medium, an effect commonly referred to as dispersion, the relative phase of the two beams normally changes as the two beams propagate through the NLO medium. As a result, energy flows in one direction initially and then flows in the reverse direction as the relative phase of the two beams changes. For general propagation through a NLO medium, then, little or no net conversion of the initial radiation to the resulting radiation is observed.

However, in birefringent crystals, light beams of different polarizations also travel at different speeds. Thus if an orientation of a birefringent NLO crystal can be found such that the speed of the initial beam with one polarization perfectly matches the speed of the desired resultant beam of different wavelength and polarization, then the relative phase will remain constant as the two beams traverse the length of the crystal, and energy will always flow in one direction (initial to resultant). Maintaining a constant phase relationship in this manner is referred to as birefringent phase matching.

The efficiency with which power is transferred from the initial to the resultant beams also depends on the magnitude of the nonlinear optical coefficients, which vary with orientation in the NLO crystal. In general, the crystal orientation that couples the initial and resultant beams through the highest nonlinear optical coefficients is not the same as the orientation required for phase matching. Thus, efficient NLO frequency conversion processes are limited to those for which orientations of the polarizations and propagation direction of the initial and resultant beams within an NLO crystal simultaneously both satisfy the phase matching condition and have a sufficiently high nonlinear optical coupling to provide frequency conversion.

An alternative to birefringent phase matching that alleviates some of the difficulties in achieving efficient frequency conversion is quasi-phase matching (QPM). In the absence of birefringent phase matching, as the initial and resultant beams get out of phase, the direction of energy flow would normally change. However, if the NLO coefficient is also changed as the beams become out-of-phase, energy can continue to flow in the same direction. This approach can be implemented in ferroelectric crystals by alternating the orientation of the ferroelectric domains (effectively changing the sign of the NLO coefficient) with a period that is equivalent to the distance required for the relative phase of the initial and resultant beams to change by π. Such a “periodically poled” structure is shown in FIG. 1.

As shown in FIG. 1, a periodically poled material 100 can be arranged such that poling domains 102 are oriented in a first direction and poling domains 104 are oriented in an opposite direction. The ferroelectric domain structure such as the alternating domain regions 102 and 104 shown in FIG. 1 is most often created by applying an electric field greater than the ferroelectric coercive field in crystal 100 via a patterned electrode on crystal 100. In contrast to birefringent phase matching (BPM), QPM allows for efficient frequency conversion for any interaction within the transparency range of crystal 100. In addition, the periodic structure can be designed to make use of the highest nonlinear optical coefficients of crystal 100, thereby significantly increasing conversion efficiency.

Another significant advantage to QPM is that the phase-matching condition is typically less sensitive to spectral and temperature variation than that condition is for BPM. The spectral and temperature bandwidth can be further increased by intentionally “blurring” the domain period. Additionally, complex domain structures can be engineered for multiple or cascaded frequency conversion allowing for resultant wavelengths or multiple resultant wavelengths that are not possible with a single crystal via birefringent phase matching.

The most common QPM devices have been produced by periodically reversing the ferroelectric domains in congruent lithium niobate crystals via electric field poling (referred to as periodically poled lithium niobate, or PPLN). Other ferroelectric crystals that have been periodically poled by applying an external electric field include lithium tantalate (an isomorph of lithium niobate) and KTiOPO4 (KTP) and its isomorphs RbTiOPO₄, KTiOAsO₄, and RbTiOAsO₄ (also known as RTP, KTA, and RTA, respectively).

Traditionally, crystals of lithium niobate and its isomorph lithium tantalate have been grown by the Czochralski method and are characterized by the so-called “congruent” composition. Congruent lithium niobate (CLN) and congruent lithium tantalate (CLT) have been grown from melts whose composition is somewhat deficient in lithium with respect to the ideal (i.e., stoichiometric) compositions LiNbO₃ and LiTaO₃. For example, congruent lithium niobate is grown from a melt where the ratio of Li₂O/(Li₂O+Nb₂O₅) is close to 0.485 on a molar basis. This composition is chosen because, under congruent melting conditions, the melt crystallizes to form a crystal of the identical composition. This is advantageous from the point of view of rapidly producing large crystals of highly uniform composition. On the other hand, the resulting crystals are deficient in Li and contain high concentrations of intrinsic defects (e.g., vacancies and antisites).

A significant problem encountered when using CLN or CLT for NLO frequency conversion via either birefringent or quasi-phase matching is that of so-called optical damage, also known as photorefractive damage. This effect results from the generation and migration of charge carriers in the crystal from illuminated regions to dark regions and the resulting space charge field and refractive index variation that is induced via the electro-optic effect. CLN and CLT crystals are most susceptible to optical damage when operating in the visible or shorter wavelengths at high laser power. The susceptibility of CLN and CLT crystals to photorefractive damage can be mitigated (although not eliminated) through doping of the crystals, most commonly with MgO. For example, doping of CLN with approximately 5 mol % MgO has been found to raise the damage threshold for 532 nm radiation to 1000 kW/cm², enabling the use of Mg-doped CLN for some frequency conversion applications.

The NLO conversion process is also strongly dependent on the intensity of the interacting light. FIG. 2 illustrates a frequency conversion process utilizing a NLO crystal 202. As shown in FIG. 2, an initial light beam 212 produced by a laser 204 passes through NLO crystal 202. Laser 204 includes a laser active material 208 positioned between reflecting mirrors 206 and 210, which form a laser cavity. In FIGS. 2, 3, and 4, a source of pump radiation (not shown) excites the laser medium.

Frequency conversion can be achieved by passing initial beam 212 from a high intensity initial laser 204 through an appropriately oriented NLO crystal 202, as shown schematically in FIG. 2. However, the intensity of initial beam 212 emerging from laser 204 is a small fraction of the intensity of the beam available within the initial laser cavity formed by mirrors 206 and 210. As such, in some systems, NLO crystal 202 is often placed inside the initial laser 204 cavity (i.e., between mirrors 206 and 210) to take advantage of the higher internal beam intensities inside laser 204. Such a system is illustrated in FIG. 3. Frequency conversion within the initial laser cavity of laser 204 is referred to as intracavity frequency conversion. While intracavity frequency conversion overcomes the lower power and lower conversion efficiency inherent in external cavity configurations, intracavity conversion suffers from instabilities in power, beam quality, and beam pointing. Resulting beam 214, then, can be frequency doubled from the beam internal to laser 204.

The inherent instabilities in intracavity frequency conversion can be classified into four types: 1) Polarization changes (large jumps in laser output over periods of seconds or minutes); 2) Line-hopping (changes in laser power typically less than 10%, over periods of seconds or minutes); 3) Mode-hopping (chaotic output fluctuations of a few percent, resulting in bistable operation); and 4) Backreflection (output fluctuations of a few percent at audio frequencies or below). See G. J. Dixon, “OEM markets open to diode-based visible lasers”, Laser Focus World, April, 1997.

All of these instabilities essentially result from trying to balance two processes (NLO frequency conversion and lasing) that are very sensitive to perturbations. The high q-factor (low loss) laser cavity (i.e., the cavity formed between mirrors 206 and 210) tries to resonate at its most efficient condition (wavelength and mode). In converting the initial laser wavelength to a new wavelength, which then exits the cavity, NLO crystal 202 represents the single largest loss mechanism in the laser cavity of laser 204. When the conversion process builds up to high efficiency, the cavity loss is so great that other resonant laser modes or wavelengths that were originally less efficient suddenly become the most efficient, and lasing hops to these alternate modes or wavelengths. The NLO phase matching conditions are very sensitive to polarization and wavelength so that when lasing hops to a different mode or wavelength, conversion efficiency and output drop. Once conversion efficiency drops such that the original lasing wavelength no longer suffers from high losses, the wavelength or mode hops back and efficiency and output increases and the cycle starts again. Add to this complicated balance the fact that the NLO conversion is very sensitive to temperature fluctuations, and the whole process may become chaotic and fluctuate wildly.

Polarization instabilities can be alleviated where laser material 208 is a highly anisotropic laser medium that will lase in only one polarization, or by the addition of waveplates or Brewster plates inside the laser cavity of laser 204 to allow resonance at only one polarization. Line hopping can be alleviated where laser material 208 is a laser medium with a single emission line or by inserting elements into the cavity that prohibit other emission wavelengths from resonating. Mode hopping instabilities can be addressed by insertion of apertures or elements within the laser cavity to allow only a single mode to resonate or by allowing laser 204 to resonate at many transverse modes so that the average changes very little. Back-reflection instabilities are typically dealt with by minimizing the number of surfaces within the cavity of laser 204, which is generally inconsistent with insertion of additional elements to control other instabilities described above. Thus, while a number of complex solutions can be adopted to deal with each of the four types of instabilities, reducing one type of instability may increase another and, at the very least, adds considerably to the complexity and cost of laser design.

An alternative to frequency conversion using a separate nonlinear optical crystal to convert the fundamental output of a solid state laser is to use one crystal that serves both to generate the fundamental beam and to convert that beam to a desired output wavelength. Such a system is illustrated in FIG. 4, where laser material 402 is also a NLO material and therefore combines the functions of laser material 208 and NLO crystal 202 of FIGS. 2 and 3.

This property of self-frequency conversion can be achieved by doping a NLO crystal with an active lasing ion. An example of such a crystal is NdₓY₁₋ₓAl₃(BO₃)₄ (NYAB), which has been operated as a self-doubling laser using both the 1.34 and 1.06 μm emission lines of Nd. In principle, self-frequency converting lasers have the advantages of very efficient frequency conversion, rugged compact design, and reduced parts count, thereby lowering cost and reducing cavity losses as compared to two-crystal intracavity frequency conversion. In addition, backreflection instabilities are reduced by elimination of two intracavity surfaces. However, very few crystals simultaneously satisfy the many requirements of a good laser host material and a good NLO conversion material. Therefore, to date two-crystal solutions have provided a more versatile and robust combination of properties than can be found in any self-frequency converting crystal. In addition, because birefringent phase matching is very sensitive to wavelength and temperature fluctuations, and lasing inherently heats the host crystal, other instabilities noted above become more problematic with self-frequency conversion materials.

Many of the instabilities in previous examples of self frequency doubling can be overcome by employing quasi phase-matching rather than birefringent phase-matching. In particular, the engineerable nature of QPM as compared to BPM allows for QPM structures to be fabricated that reduce the sensitivity of the lasing and frequency conversion processes to variations in mode, wavelength, and temperature.

Therefore, there continues to be a need for laser materials and for non-linear optical materials for use in obtaining coherent radiation at desired wavelengths.

### SUMMARY

In accordance with the present invention, a crystal laser material that is suitable for self frequency conversion is presented. A crystal according to the present invention includes a stoichiometric lithium niobate isomorph host material doped with at least one laser ion. In some embodiments, the stoichiometric lithium niobate crystal isomorph host material is lithium niobate. In some embodiments, the stoichiometric lithium niobate crystal isomorph host material is lithium tantalate. In some embodiments, the at least one laser ion includes ytterbium. In some embodiments, the at least one laser ion includes a rare-earth ion. In some embodiments, the stoichiometric lithium niobate crystal isomorph host material is periodically poled to provide quasi-phase matching. Additionally, further dopant ions, for example magnesium, can be included.

A laser according to the present invention, then, can include opposing mirrors that form a laser cavity, one of the opposing mirrors allowing passage of a portion of a light beam; a stoichiometric lithium niobate crystal isomorph host material doped with at least one laser ion positioned in the laser cavity; and a pump source that produces excitation for at least one of the at least one laser ions. The stoichiometric lithium niobate crystal isomorph host material can be lithium niobate or lithium tantalate. The laser dopant can be a rare earth ion, for example Yb. Further dopants such as Mg can be added.

A method of forming a laser crystal according to the present invention includes mixing constituent powders to form a mixture; melting the mixture in a crucible placed in a furnace to form a laser-ion doped lithium rich melt; placing a seed crystal into the melt; rotating the seed crystal at a rotation rate and pulling the seed crystal from the melt at a pull rate while lowering the temperature of the furnace at a temperature rate to grow the resulting crystal; and cooling the resulting crystal, wherein the resulting crystal is a stoichiometric lithium niobate crystal isomorph host doped with the laser ion. In some embodiments, the constituent powders include 58 mol % Li₂O, 42 mol % Nb₂O₅, and Yb₂O₃. In some embodiments, the constituent powders include 60 mol % Li₂O, 40 mol % Ta₂O₅, and Yb₂O₃. In some embodiments, the laser-ion doped lithium rich melt includes about 0.5% to about 1% Yb doping. In some embodiments, the initial temperature of the furnace while melting the mixture is about 1200° C. Further, in some embodiments the rotation rate can be about 2 to about 3 rpm, the pull rate can be about 0.1 to about 0.2 mm/hr, and the temperature rate can be about 0.05 to about 0.2° C./hr. In some embodiments, the constituent powders include a lithium oxide and a tantalum oxide. In some embodiments, the rotation rate can be between about 2 and about 30 rpm, the puling rate can be between about 0.1 to about 2 mm/h, and the cooling rates can be in the range of about 0.05 to about 0.5° C./h.

These and other embodiments are further discussed below with reference to the following figures.

### BRIEF DESCRIPTION OF THE FIGURES

FIG. 1 illustrates an inverted domain pattern in a nonlinear optical crystal used for quasi-phase matching.

FIG. 2 illustrates frequency conversion using a NLO crystal external to the laser cavity.

FIG. 3 illustrates frequency conversion using an intracavity NLO crystal

FIG. 4 illustrates self-frequency conversion using a NLO crystal doped with a laser ion.

FIG. 5 illustrates the energy level diagram of Yb dopant ions in stoichiometric lithium niobate with absorption transitions.

FIG. 6 illustrates a laser system according to an embodiment of the present invention.

FIG. 7 illustrates a growth apparatus for growing crystals according to embodiments of the present invention.

FIGS. 8A and 8B are photographs of Mg-doped stoichiometric lithium niobate grown with methods according to the present invention.

FIGS. 8C and 8D are photographs of Yb doped stoichiometric lithium niobate grown with methods according to embodiments of the present invention.

FIGS. 8E and 8F are photographs of Yb doped stoichiometric lithium tantalate grown with methods according to embodiments of the present invention

FIG. 9 illustrates an apparatus for determining Curie temperature measurements utilized to determine the stoichiometry of crystals grown according to embodiments of the present invention.

FIG. 10 illustrates a Curie temperature measurement utilized to determine the stoichiometry of crystals grown according to embodiments of the present invention.

FIG. 11 illustrates the UV edge shift in crystals grown according to embodiments of the present invention in comparison with congruent crystals.

FIG. 12 illustrates a measurement of the infrared spectra due to OH⁻ in crystals according to embodiments of the present invention to determine the degree of stoichiometry.

FIG. 13 illustrates the absorption spectrum of Yb doped stoichiometric lithium niobate grown according to embodiments of the present invention.

FIG. 14 illustrates an apparatus for performing emission spectra analysis.

FIG. 15 shows the emission spectra of Yb doped stoichiometric lithium niobate grown according to embodiments of the present invention.

FIG. 16 illustrates the energy level diagram of Yb in stoichiometric lithium niobate with emission transitions.

FIG. 17 illustrates an apparatus for determining the photorefractive damage susceptibility of crystals.

FIG. 18 illustrates the photorefractive damage susceptibility of stoichiometric lithium niobate in comparison with congruent lithium niobate.

FIG. 19 illustrates an apparatus for determining Electric Field poling susceptibility of crystals.

FIG. 20 shows a hysteresis curve for electric poling of Yb doped stoichiometric lithium niobate grown according to embodiments of the present invention.

FIG. 21 illustrates periodic poling of crystals according to embodiments of the present invention.

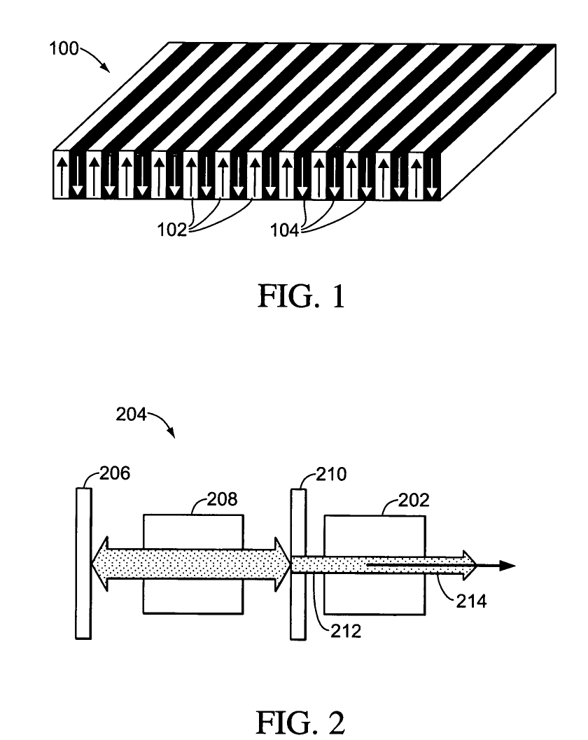

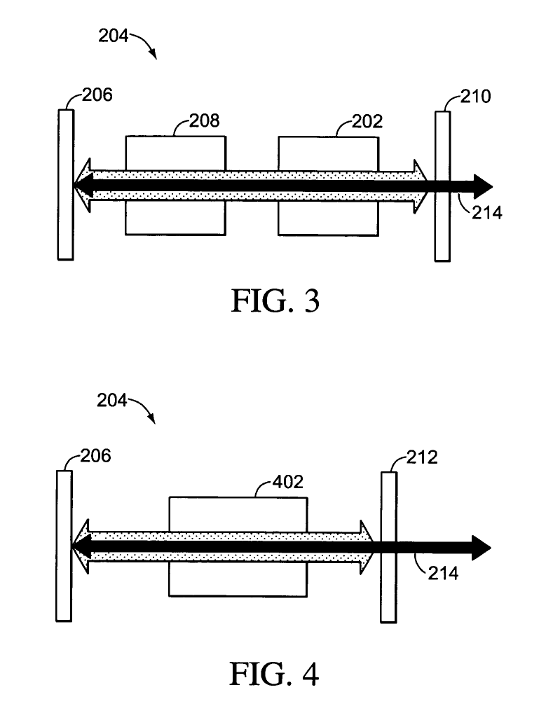

In the figures, elements having the same designation have the same or similar function.

### DETAILED DESCRIPTION

In accordance with embodiments of the present invention, a laser crystal formed from a stoichiometric lithium niobate crystal isomorph host doped with a laser ion is presented. In some embodiments, Yb-doped stoichiometric lithium niobate (Yb:SLN) and Yb-doped stoichiometric lithium tantalate (Yb:SLT) are examples of laser crystals according to the present invention. Single crystals formed from Yb-doped stoichiometric lithium niobate and Yb-doped stoichiometric lithium tantalate can be periodically poled and utilized as self frequency converting laser materials. Such a material can be employed to efficiently generate laser radiation at a variety of wavelengths with improved beam qualities so as to be useful in a variety of applications including entertainment and projection systems, optical communications, optical data storage, medical and surgical treatments, industrial machining, scientific spectroscopy and instrumentation, target designation and tracking, missile and ordinance countermeasures, and standoff detection of chemical and biological agents.

Rare-earth doped crystals of CLN and CLT have previously been grown, and their optical properties, laser activity, and self-frequency doubling have been reported. See J. Jones, J. de Sandro, M. Hempstead, D. Shepherd, A. Large, A. Tropper, J. Wilkinson, Opt. Lett. 20, 1477 (1995); E. Montoya, A. Lorenzo, L. Bausa, J. Phys.: Condens. Matter 11, 311 (1999); E. Montoya, J. Capmany, L. Bausa, T. Kellner, A. Diening, G. Huber, Appl. Phys. Lett. 74, 3113 (1999); E. Montoya, J. Sanz-Garcia, J. Capmany, L. Bausa, A. Diening, T. Kellner, G. Huber J. Appl. Phys. 87, 4056 (2000); J. Capmany, V. Bermudez, E. Dieguez, Appl. Phys. Lett. 74, 1534 (1999); and J. Capmany, E. Montoya, V. Bermudez, D. Callejo, E. Dieguez, L. Bausa, Appl. Phys. Lett. 76, 1374 (2000); T. Lukasiewicz, W. Ryba-Romanowski, J. Sokolska, M. Swirkowicz, S. Golab, Z. Galazka, Growth and optical properties of doped LiTaO₃ single crystals, Crystal Research and Technology 36, 127-134 (2001); J. Capmany, “Self-frequency converted lasers enable a broad range of applications,” Laser Focus World 39, 143-149 (2003). Rare-earth doped SLN has also been reported. See J. W. Shur, W. S. Yang, S. J. Suh, J. H. Lee, T. Fukuda, and D. H. Yoon, Optical Properties of Er doped congruent and stoichiometric LiNbO₃ single crystals, Crystal Research and Technology 37, 353-358 (2002). Congruent lithium niobate (CLN) has been doped with Yb³⁺ and laser action demonstrated in Ti-diffused Yb-doped waveguides, but lasing was limited due to photorefractive damage. See J. Jones et al., Opt. Lett. 20, 1477. Bulk Mg:CLN has also been doped with Yb, and laser action and self frequency doubling via birefringent phase matching (BPM) have been demonstrated. See E. Montoya et al., J. Phys.: Condens. Matter 11, 311; E. Montoya et al., Appl. Phys. Lett. 74, 3113; and E. Montoya et al., J. Appl. Phys. 87, 4056.

Quasi-phase matching (QPM) frequency doubling has been demonstrated in Yb:CLN and Yb:Mg:CLN crystals. See J. Capmany et al., Appl. Phys. Lett. 74, 1534 and J. Capmany et al., Appl. Phys. Lett. 76, 1374. In these investigations, the QPM structure was produced during crystal growth by displacing the crystal growth axis from the symmetry axis of the temperature field, resulting in a periodic temperature fluctuation of the growth interface as the crystal rotates. The QPM period was fixed by selecting the rotation rate and pulling rate. In the case of Yb:CLN, although frequency doubling of an externally generated laser beam was reported, neither sustained lasing nor self-frequency doubling was obtained. Transitory lasing (less than one second) was observed but quickly ceased, possibly due to photorefractive damage. In the case of Yb:Mg:CLN, lasing and self-frequency doubling was demonstrated. However in both references cited above (J. Capmany et al., Appl. Phys. Lett. 74, 1534 and J. Capmany et al., Appl. Phys. Lett. 76, 1374) the QPM structures produced during growth were noted to be inhomogeneous over large areas, and the maximum reasonably homogenous device that could be fabricated had an interaction length of less than 3 mm. The maximum calculated effective nonlinear optical coefficient, d_{eff}, in these cases was less than ⅓ the theoretical d_{eff}, providing further indication of inhomogeneous QPM. Wide variation in the QPM period is to be expected when producing QPM structures in this fashion, as the complex interdependence of many factors affecting crystal growth makes it extremely difficult to precisely control the period of the induced fluctuation over the time required to grow several millimeters.

Although Yb-doped CLN has previously been described, Yb-doped SLN (and SLT), which has important advantages over the CLN host, has not previously been produced.

Both SLN and SLT have advantages over CLN and CLT with regard to self frequency conversion in general and quasi-phase matched frequency conversion in particular, including 1) lower coercive field allowing fabrication of larger aperture devices with greater ease, 2) higher optical damage threshold allowing high laser powers to be generated particularly in the visible wavelengths, and 3) broader optical transmission range allowing generation of shorter wavelength frequency converted light.

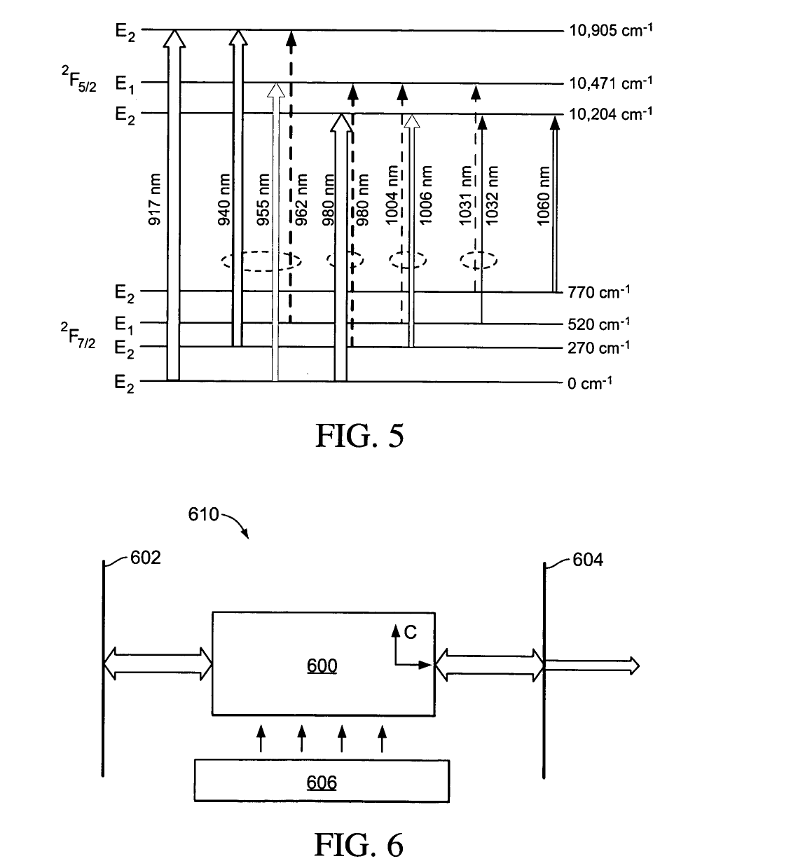

Although any laser active ion dopant can be utilized in embodiments of the present invention, Yb doping has advantages over other rare earth dopants with regard to lasers in general and self frequency converting laser in particular. Most notable of these advantages are 1)absorption spectrum that permits efficient diode pumping with commercially available InGaAs diodes, 2) simple energy level spectrum and corresponding absorption spectrum that eliminates reabsorption of frequency converted light, 3) low intrinsic heating due to small quantum defect and 4) anisotropic lasing in lithium niobate that promotes lasing of z-polarized light over other polarizations which is the preferred polarization for QPM interactions. FIG. 5 illustrates an energy level diagram of Yb in SLN. Other suitable laser ion dopants such as the other rare earth ions, for example, can also be utilized.

Recently, modified crystal growth techniques have been developed that enable the production of large, uniform crystals with compositions very close to that of the ideal chemical formulae, LiNbO₃ and LiTaO₃. These so-called stoichiometric, or near-stoichiometric, crystals have compositions where the ratio of Li₂O/(Li₂O+Nb₂O₅) or Li₂O/(Li₂O+Ta₂O₅) are close to the ideal ratio of 0.50. Although slower and perhaps more difficult to grow than their congruent counterparts, stoichiometric lithium niobate (SLN) and stoichiometric lithium tantalate (SLT) display certain advantages that impact their usefulness for quasi-phase matched frequency conversion applications. In particular, the electric field required to fabricate periodically-poled devices is reduced from near 22 kV/mm in CLN and CLT to about 4 kV/mm in SLN, and to about 2 kV/mm in SLT. These substantial reductions in poling field greatly simplify the fabrication of QPM devices and allow for increased apertures and hence larger beam diameters (and correspondingly higher powers) to be handled. In addition, Mg-doped SLN has been shown to have significantly improved resistance to optical damage over traditional undoped or Mg-doped congruent crystals, with much lower MgO concentrations (1 mol %) sufficing to prevent optical damage from laser beams in the visible wavelength region. SLN and SLT also appear to have somewhat higher nonlinear optical coefficients than CLN and CLT, thereby improving the potential efficiency of the conversion processes. SLN and SLT are also transparent to somewhat shorter wavelengths than CLN and CLT. Periodically poled structures in SLN and SLT have been described in U.S. Pat. No. 6,195,197 B1, Issued on Feb. 27, 2001 to Gopalan et al., entitled “Lithium niobate single-crystal and photo-functional device” and U.S. Pat. No. 6,211,999 B1, issued on Apr. 3, 2001 to Gopalan et al., entitled “Lithium tantalate single-crystal and photo-functional device.”

The unique properties of quasi phase matched laser ion doped lithium niobate crystal isomorph host systems, such as Yb:SLN and Yb:SLT, offer the potential to overcome the limitations that have until now prevented adoption of self-frequency conversion lasers. Combining the advantages of Yb lasing, frequency conversion via electric field poled QPM structures, and high damage threshold in Yb-doped SLN or SLT will enable sources of laser radiation throughout the wavelength range from ultraviolet to mid-infrared.

FIG. 6 illustrates a laser system 610 according to some embodiments of the present invention. Laser system 610 includes a crystal 600 according to embodiments of the present invention. Crystal 600 is a laser-ion doped stoichiometric lithium niobate isomorph crystal host material, for example rare-earth doped SLN or SLT. Further, crystal 600 can be periodically poled to provide a QPM self frequency conversion laser crystal. A laser cavity is formed by mirrors 602 and 604. As is shown, mirror 604 allows transmission of a portion of the light at the desired wavelengths. Crystal 600 is positioned in the laser cavity formed by mirrors 602 and 604 and is pumped by a pump source 606. Pump source 606 provides excitation radiation for the laser-ion dopant in crystal 600, causing the lasing action of crystal 600.

When compared to previous or current technology, laser sources according to embodiments of the present invention may demonstrate one or more of the following superior attributes: Efficient diode pumping; Low thermal loading requiring only conductive cooling; Simple single resonator design yielding compact lightweight package; Efficient frequency conversion to wavelengths not currently available; Engineerability to generate wavelengths for several different applications due to QPM; Engineerability for complex nonlinear interactions including cascaded conversion interactions and tunable output; Higher powers and longer lifetimes due to lower damage susceptibility; and Reduced polarization, line-hopping, and back-reflection instabilities leading to simplified, more reliable, and less costly laser system design. Laser sources according to embodiments of the present invention may dramatically simplify the design and construction of frequency-converted lasers, resulting in substantial cost reductions, and may also make possible lasers at wavelengths not presently available.

A crystal such as crystal 600 of FIG. 6 can be cut from a larger boule to form a laser material that can simply and efficiently generate a laser beam at an initial frequency which is converted within the crystal itself to a different resultant frequency via a quasi-phase matched (QPM) nonlinear optical (NLO) frequency conversion. Formation of crystal 600 is further discussed herein. The unique properties of a self-frequency converting laser crystal 600 according to the present invention offers the potential to overcome the limitations that have prevented broad adoption of solid state intracavity frequency conversion and self-frequency conversion in particular and enable efficient cost effective sources of laser radiation at wavelengths that are not currently commercially available.

Stoichiometric lithium niobate (SLN) and stoichiometric lithium tantalate (SLT) crystals can be distinguished from the more common congruent lithium niobate (CLN) and congruent lithium tantalate (CLT) in that the compositions of the crystals are much closer to their ideal chemical formulation of LiNbO₃ and LiTaO₃ (i.e., much closer to having a 1:1 correspondence between the number of lithium ions in the crystal and the number of niobium or tantalum ions in the crystal). In some embodiments, a lithium niobate crystal is considered to be stoichiometric when the ratio Li₂O/(Li₂O+Nb₂O₅) is between about 0.49 and about 0.52. The lithium niobate isomorph lithium tantalate can be considered stoichiometric when the ratio Li₂O/(Li₂O+Ta₂O₅) is between about 0.49 and about 0.50. Stoichiometric lithium niobate and stoichiometric lithium tantalate crystals can be grown by a variety of crystal growth methods.

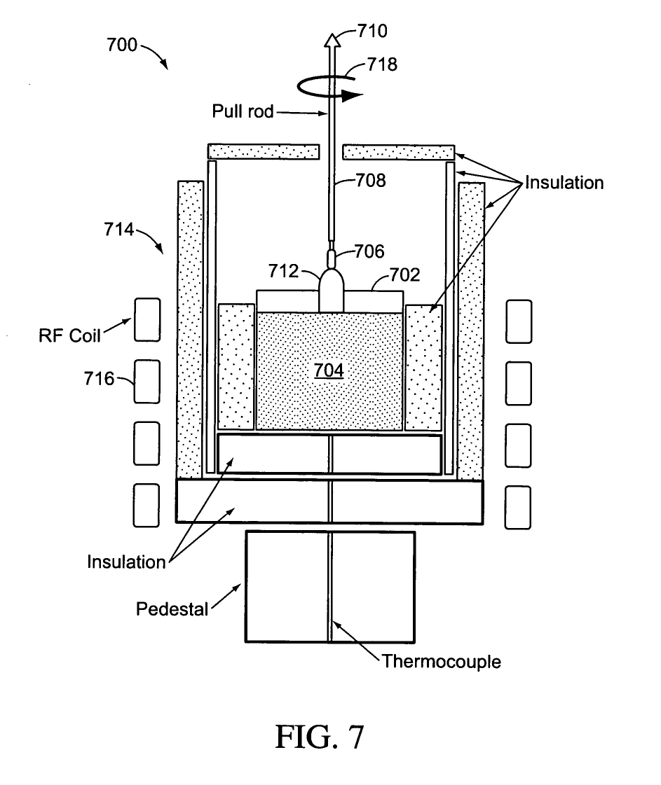

FIG. 7 illustrates a crystal growth apparatus 700 that can be utilized to grow crystals according to embodiments of the present invention. As shown in FIG. 7, apparatus 700 includes a crucible 702 in which a material can be melted in a furnace 714 to form a melt 704. A seed crystal 706 can then be mounted on a rod 708 and lowered into melt 704 or into contact with the surface of melt 704. Seed crystal 706 is a crystal of the same material as that being grown, but may not have the same stoichiometry or quality as the crystal being grown. Seed crystal 706 is then slowly rotated by a rotational motor 718 and pulled from melt 704 by motor 710 as resultant crystal 712 grows. Furnace 714 can be any furnace that can produce melt 704. As shown in FIG. 7, furnace 714 can include RF heating coils 716. In some embodiments, furnace 714 can include resistive heating elements instead. Growth of SLN can be achieved by resistive heating elements. However, growth of SLT requires a higher furnace temperature to maintain melt 704, in which case RF heating elements may be utilized.

The growth methods that can be utilized to form SLN or SLT according to the present invention utilize a solution-growth, or flux-growth process that is distinguished from the process used to grow congruent lithium niobate and congruent lithium tantalate wherein the melt is identical in composition to the crystal being grown [Li₂O/(Li₂O+Nb₂O₅) or Li₂O/(Li₂O+Ta₂O₅)≈0.485]. Solution growth processes involve use of a melt 704 that has a material composition that is different from the composition of crystal 712 grown from melt 704. In the case of SLN (or SLT), melt 704 may contain Li₂O and Nb₂O₅ (or Li₂O and Ta₂O₅) in which the composition is in the range of 58-60 mol % Li₂O and 42-40 mol % Nb₂O₅ (or 58-60 mol % Li₂O and 42-40 mol % Ta₂O₅), although other compositions (and other fluxes) are also possible. Melt 704 of this composition can be prepared by mixing constituent oxide compounds, for example, Li₂CO₃ and Nb₂O₅, or Li₂CO₃ and LiNbO₃ (or the equivalent tantalates in the case of SLT growth). The constituent powders are mixed in appropriate amounts to produce the desired overall composition in terms of the ratio Li₂O/(Li₂O+Nb₂O₅) or Li₂O/(Li₂O+Ta₂O₅) and are held in crucible 702, which is typically made of platinum or iridium, and melted in a furnace 714 which can produce temperatures in the range of 1200-1300° C. for SLN or 1500-1600° C. for SLT.

Pre-existing seed crystal 706 of LiNbO₃ or LiTaO₃ is attached to a pull rod 708 and lowered into furnace 714 until seed crystal 706 makes contact with melt 704. Seed crystal 706 is then rotated and slowly pulled vertically from melt 704. As the temperature of furnace 714 is lowered, melt 704 becomes supersaturated with respect to the solid phase, and crystalline material is deposited on seed crystal 706. Crystals with compositions close to the stoichiometric ratios (Li/Nb or Li/Ta=1.0) can thereby be produced, although some minor variation in composition is to be expected for this growth process.

Limiting the temperature range of the growth process to a small interval, and hence limiting the volume of crystal 712 produced from a given melt in a single growth run produces crystals 712 that may have negligibly small variation in Li/Nb or Li/Ta ratio and hence can be utilized in the production of self-frequency converting optical elements. Modification of the growth process, for example adding solid material continuously to melt 704 as crystal 712 is withdrawn (melt replenishment), can minimize any compositional variations in the grown crystals and increase the yield of the process, albeit with an increase in the cost and complexity of the growth process. In addition, other fluxes, for example, potassium oxide (K₂O), can be used in place of excess Li₂O in the melt to produce crystals with a highly stoichiometric composition.

In order to introduce a laser ion dopant into the SLN or SLT crystals 712, melt 704 can be doped with an appropriate chemical compound. By way of example Yb doped SLN can be grown by adding 1%-4% Yb₂O₃ to a mixture of powders composed of about 58% Li₂O and about 42% Nb₂O₅. In some embodiments, maximum Yb concentration incorporated in resulting crystal 712 can be approximately 1% and may be limited by the nature of the crystal structure and the various defects contained in resulting crystal 712. The distribution coefficient is most likely close to 1.0 for melt doping below 1 at. % Yb (i.e., the number of Yb ions in the crystal is 1% of the number of total positive ions in the crystal), although neither the solubility limit nor the distribution coefficient are well known. Although this concentration of dopant is adequate to generate the fundamental laser output of crystal 600 formed from resulting crystal 712, modifications to the growth process, for example introduction of other species to provide charge compensation for the Yb³⁺ ion substituting for either Li¹⁺ or Nb⁵⁺ (or Ta⁵⁺), or both, can be utilized to enable higher concentrations of the laser ion dopant to be incorporated in the crystal.

In some embodiments, melt 704 may also include a magnesium dopant. The incorporation of dopants such as magnesium (Mg) has been demonstrated to significantly increase the optical power threshold for causing photorefractive damage in both congruent and stoichiometric LiNbO₃. In some embodiments Mg concentrations of approximately 5% are used to appreciably increase the damage threshold in CLN, Mg concentrations close to 1% have been noted to increase the optical damage threshold of SLN to higher levels than those observed for 5% Mg:CLN. Other dopants, for example, indium (In) and scandium (Sc) have also been demonstrated to reduce the susceptibility to photorefractive damage in LiNbO₃, although these are not the only possible dopants that can have such an effect. In the case of Yb:SLN or Yb:SLT, the Yb³⁺ significantly increases the optical damage threshold (i.e., the intensity of optical radiation that can be incident on the crystal before optically damaging the crystal) in a manner similar to Mg²⁺ doping thus reducing or eliminating the need to incorporate such additional dopants in the growth of these self-frequency converting crystals, although co-doping may further reduce the optical damage susceptibility.

The growth parameters provided herein are for particular examples of growth runs. Those skilled in the art will recognize that a wide array of growth parameters (e.g., rotation rates, pulling rates, and cooling rates) can be utilized to produce crystals according to embodiments of the present invention. For example, rotation rates in the range of about 2 to about 30 rpm, pulling rates in the range of about 0.1 to about 2 mm/h, and cooling rates in the range of about 0.05 to about 0.5°/h can also be utilized. Further, the constituent mixtures provided above are also exemplary only and are not to be considered limiting. Other concentration mixtures can also produce crystals according to embodiments of the present invention.

As an example, crystals of undoped and doped SLN were grown and studied by a variety of techniques in order to characterize their overall degree of stoichiometry, the concentrations of Yb and Mg dopants in the crystals, the absorption and emission properties of Yb in this material, and the effects of doping on the photorefractive damage susceptibility. For analysis of dopant concentration, samples of each crystal grown were analyzed to determine of the concentrations of Yb and Mg. Other analyses were carried out on samples of the crystals grown. In particular, the crystals grown include an undoped SLN crystal, a 1% Yb-doped SLN crystal, a 0.5% Mg-doped SLN crystal, and a 1% Yb+0.5% Mg-doped SLN crystal. Characterization was generally limited to crystals grown from lightly doped melts as crystals from highly doped melts were of similar composition but had lesser crystalline quality.

Crystals of stoichiometric lithium niobate were grown by the top-seeded solution growth method in apparatus 714 where heaters 716 were resistive element heaters. Melt 704 was arranged with a composition corresponding to 58 mol % Li₂O and 42 mol % Nb₂O₅. (or, equivalently, 16 mol % Li₂O and 84 mol % LiNbO₃). See Y. Furukawa, K. Kitamura, S. Takeawa, K. Niwa, Y. Yajima, N. Iyi, I. Mnushkina, P. Guggenheim, J. Martin, J. Cryst. Growth 211, 230 (2000). Melts 704 were prepared from starting materials consisting of high-purity (≧99.999%) powders of “LiNbO₃” (congruent LiNbO₃, actual composition ˜48.5% Li₂O+51.5% Nb₂O₅) and Li₂CO₃. Dopants were added as MgO and Yb₂O₃ powders (99.998% pure). The powders of these materials were weighed out and mixed together and then added to a platinum crucible 702 in which they were melted. Several steps of adding the Li₂CO₃+LiNbO₃ mixture, melting, and recharging were required to fill crucible 702. Crucible 702 was cylindrical and measured 70 mm in diameter and 70 mm in height. The thin-walled (0.5 mm) crucible 702 was placed within an alumina tube of approximately 79 mm I.D.×100 mm high, and the space between the crucible and tube was packed with alumina fiber to support the crucible and prevent it from deforming during crystal growth. The weight of melt 704 was approximately 900 g, with some variation from one growth to the next. Between runs, the melt was replenished to replace the amount of LiNbO₃ extracted in the preceding growth run, as well as to adjust the melt with dopant material to adjust dopant concentrations.

As mentioned before, furnace 714, where crystal growth was conducted, was a wire-wound resistance heated furnace, with three independently controlled heating zones. Furnace 714 had a 5″ diameter vertical tube, within which the crucible was supported on a smaller diameter pedestal tube. Platinum crucible 702 was placed in the “hot zone” of furnace 714, such that temperature within the melt varied by only a few degrees. Above crucible 702, the axial temperature gradient in furnace 714 at temperature was about 5° C./cm.

Growth of resulting crystal 712 was initiated on a seed 706 of stoichiometric LiNbO₃. Rod 708 included a Pt seed holder for holding seed 706 attached to an alumina tube (pull rod). Seed crystal 706 measured 6.3 mm in diameter and 10-20 mm long. In all cases, the vertical axis of seed 706 was the z-direction (or c-axis) of the LiNbO₃ crystal.

A load cell (not shown) can be used to monitor the weight of resulting crystal 712 during growth. Seed 706 was suspended from a rod 708 that includes a platinum fixture at the end of an alumina rod. The alumina rod can be held by a centering chuck (not shown) beneath the load cell (not shown), which in turn was attached to rotation/translation mechanisms 708 and 710. During growth, seed 706 was rotated at about 2-3 rpm and pulled at about 0.1-0.2 mm/h. Growth was initiated by dipping seed 706 into melt 704 and partially melting back the end of seed 706. The temperature of furnace 714, initially near 1200° C., was lowered at rates of 0.05-0.2°/h, over a temperature interval of 15-25 degrees, after which resulting crystal 712 was withdrawn from the melt and slowly cooled to room temperature. Each growth run took 7-10 days for growth followed by 2-3 days to cool the crystals to room temperature.

Several crystals were grown according to the method described herein. A first melt was prepared as discussed above without any dopants and a first crystal was grown. Following this, the melt composition was modified to include 1 at % Yb in the melt and a second crystal was grown. Subsequently, crystals were grown from melts with 2 at % Yb and 4 at % Yb in the melt. This melt was then discarded. After cleaning all residue from the crucible, a new melt was prepared which was doped with 0.5 at % Mg. A Mg:SLN crystal was grown from this melt, and then the melt was modified to contain 1 at % Yb in addition to the 0.5 at % Mg. Another growth run was performed, producing a Mg,Yb:SLN crystal, after which additional Yb₂O₃ was added, raising the concentration to 2 at % Yb. In each case, following growth of a doped crystal, the amount of dopant removed in the previous growth run was replenished on the assumption that the concentration of dopant in the crystal was the same as that in the melt. Although the actual dopant concentrations were later found, by chemical analysis, to differ slightly from these expected amounts, the resultant inaccuracies in melt composition are considered to be insignificant given that a relatively small fraction of the melt was crystallized in each growth run.

The weight of resulting crystals 712 grown as described above varied from 66 to 152 g. The non-Yb-doped crystals had a nearly circular cross-section, with a diameter of about 38 mm and a length of about 38 to about 45 mm. Yb-doped crystals (with or without Mg) had a different shape, being much more triangular in cross-section, but with the dominant growth facets changing from beginning to end of the growth. The crystals varied in diameter from about 30 to about 45 mm and in length from about 30 to about 50 mm.

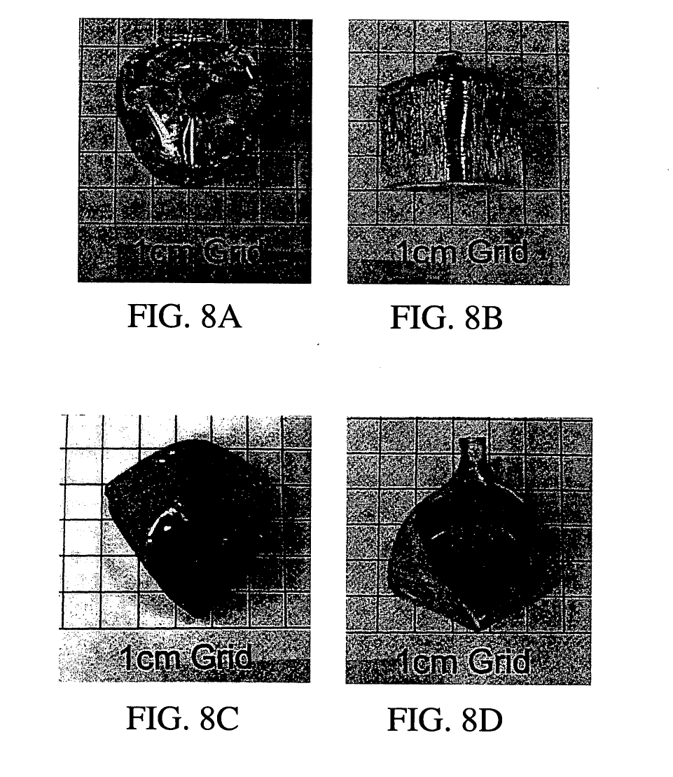

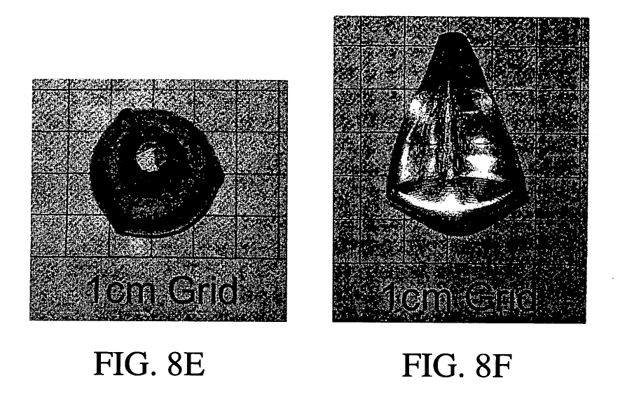

FIGS. 8A and 8B show a top view and a side view, respectively, of a resulting crystal 712 of Mg-doped SLN crystal grown according to the above described method. FIGS. 8C and 8D show a top view and a side view, respectively, of a resulting crystal 712 of Mg,Yb-doped crystal grown according to the above described method. FIGS. 8E and 8F show a top view and side view, respectively, of Yb:SLT grown according to some embodiments of the present invention. All growth runs produced crystals with large areas of transparent material. Undoped and lightly doped crystals were generally free of visible flaws, although more highly doped crystals did present evidence of inclusions and growth striations.

Several tests were performed on samples taken from resultant crystals 712. Resultant crystals 712 that were tested included an undoped SLN crystal (SLN), a 1% Yb-doped SLN crystal (Yb:SLN), a 0.5% Mg-doped SLN crystal (Mg:SLN), and a 1% Yb and 0.5% Mg-doped SLN crystal (Yb:Mg:SLN). Tests performed resulted in determination of the crystal stoichiometry, determination of the dopant concentration, measurements of absorption and luminescence spectroscopic properties, and photorefractive damage susceptibility tests. Further, susceptibility for electric field poling was also tested.

Crystal stoichiometry can be determined in a number of ways, including Curie temperature measurements, measurement of the UV absorption edge, and measurement of the OH⁻ absorption. The most commonly employed method to determine the Li/Nb ratio of lithium niobate crystals is measurement of the ferroelectric-paraelectric transition temperature, referred to as the Curie temperature or T_{C}. The Curie temperature has been found to increase nearly linearly with c_{Li} (defined as 100×[Li]/([Li]+[Nb])), which indicates the concentration of lithium ions in the crystal, by over 60° C. as the crystal composition changes from congruent (c_{Li}=48.38) to stoichiometric (c_{Li}=50.0%). See P. Bordui, R. Norwood, D. Jundt, M. Fejer, J. Appl. Phys. 71, 875 (1992); J. Carruthers, G. Peterson, M. Grasso, P. Bridenbaugh, J. Appl. Phys 42, 1846 (1971); N. Iyi, K. Kitamura, F. Izumi, J. Yamamoto, T. Hayashi, H. Asano, S. Kimura, J. Sol. State. Chem. 101, 340 (1992); and H. O'Bryan, P. Gallagher, C. Brandle, J. Am. Ceram. Soc. 68, 493 (1985). At least three relations have been presented in the literature relating Curie temperature to composition:
T_{c}=39.064 c_{Li}−746.73
(P. Bordui et al., Appl. Phys. 71, 875);
T_{c}=39.26 c_{Li}−760.67
(N. Iyi et al., J. Sol. State. Chem. 101, 340); and
T_{c}=9095.2−369.05 c_{Li}+4.228 c_{Li}²
(H. O'Bryan et al., J. Am. Ceram. Soc. 68, 493).

Predicted Curie temperatures based on the equations above range from 1137-1143° C. for CLN (c_{Li}=48.38%) and from 1202-1213° C. for SLN (c_{Li}=50.0%). Differences in these relations likely result from inaccuracies in the determination of the compositions of samples from which the relations were derived, differences in impurity concentrations which are also known to effect Curie temperatures, or experimental methodology. While different investigations have given slightly different relations between Li₂O content and T_{C}, lithium niobate compositions determined in this way are expected to have a relative accuracy of 0.02% and absolute accuracy of 0.2%.

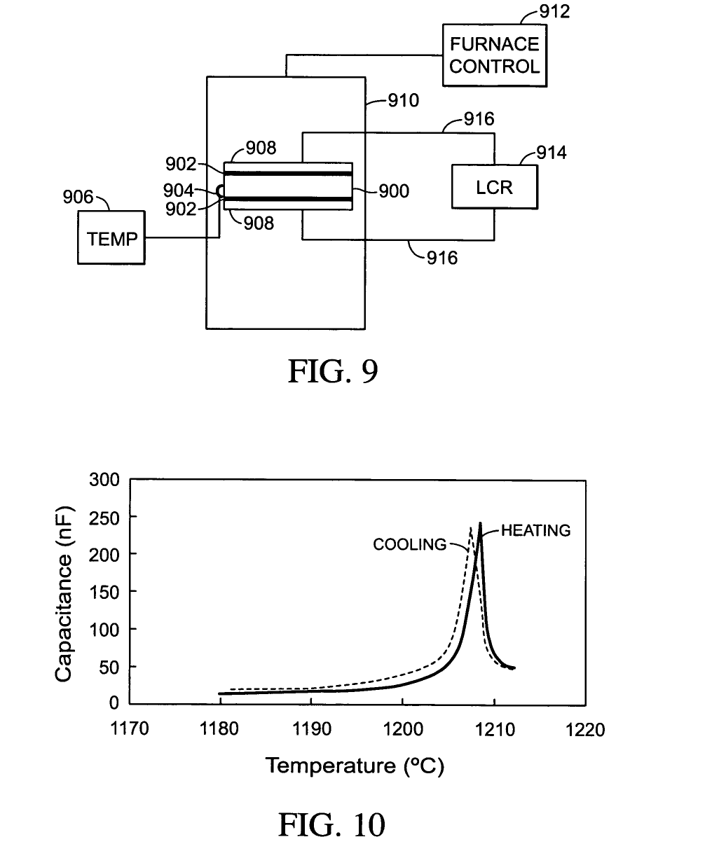

Dielectric anomalies are associated with ferroelectric-paraelectric phase transitions. As such, Curie temperatures of a sample crystal were determined by monitoring the capacitance as a function of temperature as illustrated in FIG. 9. Samples 900 from each of resulting crystals 712 were fabricated in the form of z-plates measuring 5×5×0.5 mm³, and platinum paint 902 was applied to the z-faces. The samples were placed between platinum contact plates 908 inside a vertical tube furnace 910. Platinum wires 916 connected to contact plates 908 extended outside furnace 910 and were connected to an LCR meter 914, which can be Hewlett Packard model 4262A LCR meter. A thermocouple 904, which can be a Type R thermocouple, was placed at the same height as the sample and within 5 mm of the center of the sample for all experiments. Thermocouple 904 was coupled to a thermocouple monitor 906 Temperature resolution was ±1° C. Furnace 910 can be controlled by a furnace controller 912.

The capacitance and temperature were recorded as the sample was heated at approximately 3° C./min through the Curie temperature near 1200° C. After passing through the Curie temperature, the capacitance was similarly monitored while cooling through the phase transition. As an example, the capacitance versus temperature for undoped SLN is shown in FIG. 10. The Curie temperature is indicated by the position of the peak in FIG. 10. As shown in FIG. 10, the solid black line is the capacitance versus temperature relationship measured during heating of sample crystal 900 and the gray line is the capacitance versus temperature relationship measured during cooling of sample crystal 900.

Curie temperatures for SLN, Yb:SLN, Mg:SLN, and Yb:Mg:SLN according to embodiments of the present invention are shown in Table 1. For comparison, values for a sample of CLN are also included in Table 1. The value for congruent LiNbO₃, 1138° C., is within the range of values expected from the three equations given above. Using these equations given to determine the composition of growth run SLN yields a value c_{Li} ranging from 49.9% to 50.1%, confirming the highly stoichiometric composition of the undoped SLN crystal. While fewer studies are available regarding Mg:SLN, Mg doping of SLN crystals has been reported to increase the Curie temperatures by as much as 20° C. in good agreement with Curie temperature measured on samples of Mg:SLN according to the present invention grown as described above. See Y. Furukawa, K. Kitamura, S. Takekawa, K. Niwa, Y. Yajima, N. Iyi, I. Mnushkina, P. Guggenheim, J. Martin, J. Cryst. Growth 211, 230 (2000) and B. Grabmaier, F. Otto, J. Crystal Growth 79, 682 (1986). While Mg doping increases T_{c} of SLN crystals in this investigation by 13° C., Yb doping decreases the T_{c} by 43° C. Consistent with these results co-doping of SLN with Mg and Yb gives a Curie temperature well below that of SLN but higher than that of SLN doped with Yb only.

TABLE 1
Curie Temperature Measurements

| | | Transition Temperature |
|---|---|---|
| Sample # | Composition | (° C.) |
| CLN | Congruent LN | 1138 |
| SLN | Undoped SLN | 1207 |
| Yb:SLN | 1% Yb:SLN | 1164 |
| Mg:SLN | 0.5% Mg:SLN | 1220 |
| Yb:Mg:SLN | 0.5% Mg, 1% Yb:SLN | 1170 |

Another indication of the stoichiometry of a lithium niobate crystal is the location of the UV band edge. The UV band edge of lithium niobate shifts to shorter wavelengths as crystal composition goes from congruent to stoichiometric. See I. Foldvari, K. Polgar, R. Voszka, R. Balasanyan, Cryst. Res. Technol. 19, 1659 (1984); G. Malovichko, V. Grachev, E. Kokanyan, O. Schirmer, K. Betzler, B. Gather, F. Jermann, S. Klauer, U. Schlarb, M. Wohlecke, Appl. Phys. A 56, 103 (1993); and M. Wohlecke, G. Corradi, K. Betzler, Appl. Phys. B 63, 323 (1996). The magnitude of the blueshift is 10-20 nm depending on the crystal composition and the absorption level that is defined as the bandgap energy. Wohlecke et al., Appl. Phys. B 63, 323, fit experimental data to obtain a second order polynomial equation for the UV band edge as a function of c_{Li} from which lithium niobate crystal composition can be determined with relative accuracy of 0.02% and absolute accuracy of 0.1%. Kovacs et al., L. Kovacs, G. Ruschhaupt, K. Polgar, G. Corradi, M. Wohlecke, Appl. Phys. Lett. 70, 2801 (1997), used empirical data to relate the photon energy of the band edge to the square root of the crystal composition. The latter relation is more accurate in the near stoichiometric limit with absolute and relative accuracy of better than 0.01% and absolute accuracy of 0.1%.

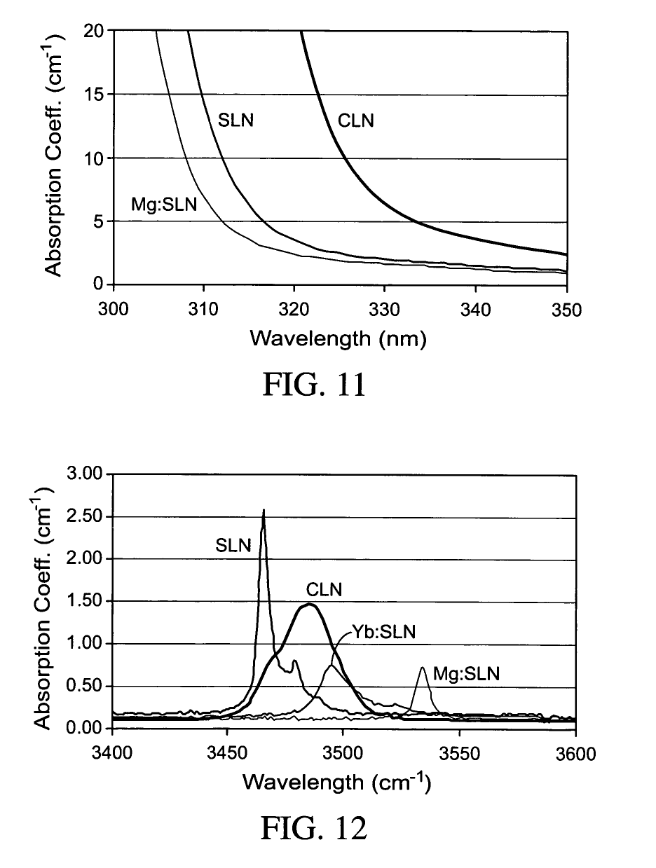

Optical absorption spectra were obtained from samples of each of resulting crystals 712 in the wavelength range of 200-2500 nm using an automated Cary 14 spectrophotometer. Absorption spectra near the UV band edge for CLN (obtained from a commercial source), SLN, and Mg-doped SLN (Mg:SLN) are shown in FIG. 11. All samples were 1 mm thick in the direction of beam propagation, which was perpendicular to the c-crystallographic axis, and measurements were taken with polarization both parallel and perpendicular to the z-axis. No significant difference in position of the UV band edge was noted for Yb doping of SLN or Mg:SLN.

Using expressions for the UV absorption edge given by Kovacs et al. and Wohlecke et al., along with the spectral resolution used in the above measurements, the composition of undoped SLN obtained from SLN is found to be c_{Li}=49.8%±0.05%. The parameter c_{Li} of SLN determined in this way is only slightly lower than that determined from Curie temperature measurements and similarly verifies the highly stoichiometric composition of the SLN crystals grown according to the present invention.

Doping of SLN with Yb did not change the UV band edge position within the accuracy limits of the measurements made during this effort. However, the band edge of Mg-doped SLN was shifted to shorter wavelengths by approximately 3.5 nm as compared to undoped SLN. While a quantitative expression relating the fundamental band edge to composition in Mg-doped crystals has not yet been determined, a similar shift in SLN has been previously reported. See K. Niwa, Y. Furukawa, S. Takekawa, K. Kitamura, J. Crystal Growth 208, 493 (2000).

Another indication of stoichiometry is a measurement of the OH⁻ absorption by infrared spectroscopy. Nearly all lithium niobate contains trace amounts of hydrogen in the form of OH⁻ molecules. Differences have been noted in the shape and linewidth of OH⁻ absorption as stoichiometry varies. CLN crystals are characterized by a broad (Full Width at Half Maximum (FWHM) of about 30 cm⁻¹) asymmetric OH⁻ absorption at 3485 cm⁻¹. As the composition changes from congruent to nearly stoichiometric, this absorption shifts slightly with more resolved structure and is dominated by a narrow absorption line at 3466 cm⁻¹ with a secondary line at 3479 cm⁻¹. OH⁻ bands with halfwidth less than 3 cm⁻¹ (FWHM about 6 cm⁻¹) have been observed in samples of highly stoichiometric lithium niobate grown from K₂O flux. The relative intensity of the principal absorption and particular satellite bands have been noted to vary by at least two orders of magnitude in the c_{Li}=49.5-50.0% range, which should allow for determination of composition with a relative accuracy of about 0.01%. These characteristic absorption spectra are practically unchanged as Mg doping levels are increased until a certain threshold dopant concentration is reached and the absorption dramatically shifts to 3534 cm⁻¹ for both CLN and SLN.

Without being limited to any particular theory, the abrupt shift in OH⁻ absorption with Mg doping has been generally interpreted as follows: Hydrogen impurities form O—H molecules in the oxygen triangle just above the Nb site. Nb ions also occupy Li sites to charge compensate for Li vacancies (present in much greater concentrations in congruently grown crystals). When these crystals are doped with MgO at low concentrations, Mg²⁺ ions occupy Li sites and compensate for Li vacancies thereby reducing the number of Nb_{Li} (designating a Nb ion on a Li site). Once the concentration of Mg reaches a threshold such that all the Li vacancies are compensated by Mg_{Li}, Mg²⁺ ions begin to occupy Nb sites (most likely near OH⁻ molecules). The change in local perturbation (Mg²⁺ rather than Nb⁵⁺) changes the characteristic OH⁻ molecular vibration and correspondingly the infrared absorption. Because SLN has much lower Li vacancy and compensating Nb antisite concentration, much lower Mg doping concentrations are required to create Mg_{Nb} sites and shift the OH⁻ absorption band. Threshold Mg doping for CLN is approximately 5%, whereas thresholds of less than 1% have been observed for SLN crystals grown from Li-rich melts. See Y. Furukawa, K. Kitamura, S. Takekawa, K. Niwa, Y. Yajima, N. Iyi, I. Mnushkina, P. Guggenheim, J. Martin, J. Cryst. Growth 211, 230 (2000). Other impurities and post growth annealing have also been reported to affect OH⁻ spectral linewidths and intensities. See M. Wohlecke, G. Corradi, K. Betzler, Appl. Phys. B 63, 323 (1996).

Unpolarized optical absorption spectra in the 3400-3600 cm⁻¹ (2.78-2.94 μm) spectral region were recorded using a Nicolet model 550 FTIR spectrometer. Samples taken from resulting crystals 712 were 1 mn thick and the beam propagation direction was perpendicular to the z-axis (c crystallographic axis). Characteristic spectra are shown in FIG. 12. The shift of OH⁻ absorption in FIG. 12 from 3466 cm⁻¹ for SLN to 3534 cm⁻¹ for Mg:SLN with only 0.64 at % Mg doping in the crystal is further verification of the highly stoichiometric composition of SLN crystals grown according to the methods described herein. As shown in FIG. 12, the results for Yb:SLN also show a shift of the OH⁻ absorption to higher frequency, as is found for Mg: SLN. Although the shift is not as large, this result nevertheless suggests that Yb behaves similarly to Mg in terms of first occupying Li sites in the structure before substituting on Nb sites. Presumably the spectral differences between Yb:SLN and Mg:SLN reflect the differing nature of the (Yb³⁺_{Nb}—OH⁻) compared to (Mg²⁺_{Nb}—OH⁻) complexes.

As is amply demonstrated above, resulting crystal 712 of SLN, Yb:SLN, Mg:SLN, or Yb:Mg:SLN grown according to the methods described herein are stoichiometric crystals of lithium niobate. Tests based on OH⁻ absorption, Curie temperature, and UV edge shifts each indicate similar degrees of stiochiometry. In addition to stoichiometry, dopant concentrations were also measured on samples of resulting crystals 712.

Samples were prepared from resulting crystals 712 of SLN, Yb:SLN, Mg:SLN, and Yb:Mg:SLN grown according to the methods described herein and submitted to a commercial analytical laboratory for composition analysis. Mg and Yb concentrations in the crystals were determined by inductively-coupled plasma optical emission spectroscopy (ICP-OES). Results of measured Mg and Yb concentrations in the crystals are presented in Table 2 along with their corresponding melt concentrations calculated from composition of starting powders. In Table 2, the designation “N.D.” indicates Not Determined and concentrations are expressed in atomic %.

TABLE 2
Chemical Analyses of Yb and Mg Concentrations

| Run Number | Yb in melt | Yb in crystal | Mg in melt | Mg in crystal |
|---|---|---|---|---|
| SLN | 0 | N.D. | 0 | N.D. |
| 1% Yb SLN | 1 | 0.83 | 0 | 0.02 |
| 2% Yb:SLN | 2 | 0.78 | 0 | N.D. |
| 4% Yb:SLN | 4 | 0.70 | 0 | N.D. |
| 0.5% Mg:SLN | 0 | 0.00 | 0.5 | 0.64 |
| 1% Yb, | 1 | 0.67 | 0.5 | 0.49 |
| 0.5% Mg:SLN | | | | |
| 2% Yb, 0.5% | 2 | 0.69 | 0.5 | 0.52 |
| Mg SLN | | | | |

From the data in Table 2, it is estimated that the segregation coefficient (ratio of concentration in crystal to concentration in melt) for Mg in SLN according to the present invention is around 1-1.3. In the case of Yb in SLN according to the present invention, the segregation coefficient appears to be around 0.7-0.8. However, the concentration in the crystal does not appear to increase with increasing melt concentration. This suggests a solubility limit for Yb of around 0.7-0.8 atomic % in SLN according to the present invention.

The concentration of Yb in all the Yb-doped melts 704 exceed the estimated solubility limit. Therefore, it is expected that melt 704 became increasingly enriched in Yb as the series of growth runs proceeds. Melt compositions with Yb doping much higher than the maximum limit that could be incorporated in the crystal may have contributed to generally poorer quality crystals that resulted from highly doped embodiments of melt 704. Although this suggests the amount of Yb that can be added to the crystal is limited, the concentration (nearly 1 atomic % Yb, corresponding to around 3×10²⁰ ions/cm³) is well within the range that may be useful for laser operation in this material. Furthermore, it might be possible to raise the solubility limit and incorporate additional Yb by intentionally adding other dopants or changing the Li/Nb ratio to produce compensating defects.

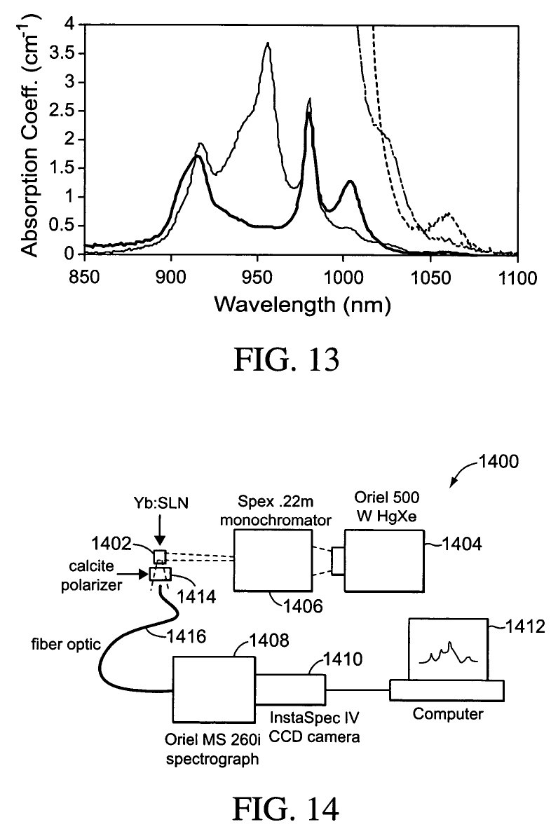

FIG. 13 shows the polarized optical absorption spectra near 1000 nm obtained from a 5 mm thick sample prepared from resulting crystal 712 of 1% Yb:SLN. Absorption spectra as shown in FIG. 13 can be taken with a Cary-14 spectrophotometer. Similar absorption spectra obtained from other crystals grown according to the present invention were consistent with the small differences in Yb concentration in the crystal, as determined through ICP-OES, regardless of dopant level added to melt 704 during growth of resulting crystal 712.

The spectra shown in FIG. 13 are nearly identical to those previously reported for Yb doping of CLN. See E. Montoya, A. Lorenzo, L. Bausa, J. Phys.: Condens. Matter 11, 311 (1999). FIG. 13 shows the near IR absorption spectra obtained from a sample of Yb:SLN resulting crystal 712 according to the present invention. The thick gray line represents π polarization (E//z) and thin black line represents σ polarization (E⊥z). Dashed lines are magnified by 10.

The energy level diagram of Yb in SLN is illustrated in FIG. 5. In FIG. 5, black transitions represent σ polarized absorptions and gray transitions represent π polarized absorption. The thickness of the transition lines represent their relative intensities. Dashed transitions are not observed in the absorption spectrum of FIG. 13 due to stronger overlapping absorptions. Lines grouped within a dashed circle make up an unresolved absorption band.

The absorption results from optical transitions from the ²F_{7/2} ground state manifold to the ²F_{5/2} excited state manifold of Yb³⁺. The C₃ site symmetry of Yb³⁺ substitutionally residing on a Li site in SLN splits the ground state into four Stark levels and the excited state into three Stark levels. Electric dipole selection rules allow E₂→E₂ transitions for both π and σ polarizations, E₁→E₁ transitions for π polarizations only, and E₂₍₁₎→E₁₍₂₎ transitions for σ polarizations only. The three strongest absorptions peaks at 917, 955, and 980 nm result from transitions between the lowest energy level in the ground state manifold to the three Stark levels of the excited state manifold. Weaker absorptions resulting from the thermally populated first higher energy Stark level of the ground state can be observed at 1006 nm and as a shoulder at 940 nm. A third absorption from this energy level underlies the 980 nm absorption resulting from the lowest energy ground state level to the lowest Stark level of the excited state. Successively weaker absorptions can be identified that represent transitions from each of the next higher energy levels within the ground state manifold. The absorption spectra of FIG. 13 can therefore be interpreted in terms of the energy level diagram shown in FIG. 5. The energy level diagram shown in FIG. 5 is very similar to that proposed by Montoya et al. for Yb:CLN. See E. Montoya et al., J. Phys.: Condens. Matter 11, 311.

More accurate determination of energy levels can be made by optical absorption experiments at low temperature (˜100 K). At low temperatures, absorptions resulting from transitions from energy levels other than the lowest energy level within the ground state manifold will be nearly eliminated due to low thermal population of higher Stark levels. As a result, the absorption spectrum will become much simpler, consisting of sharp absorption bands representing transitions from the lowest energy ground state level to the three excited state energy levels (917 nm, 955 nm, and 980 nm). Determination of the wavelengths for these transitions without overlapping absorption from weaker transitions will permit more accurate determination of the energies of the three Stark levels within the excited state manifold.

FIG. 14 illustrates a fluorescence spectrometer 1400 that can be utilized for taking fluorescent data on crystals according to the present invention. Sample crystal 1402 according to the present invention can be a Yb:SLN sample from resulting crystal 712. As shown in FIG. 14, unpolarized light from a light source 1404, which can be an Oriel Instruments 500W HgXe lamp, is passed through a monochromator 1406, which can be a Spex monochromator, and is incident on sample crystal 1402 for excitation of energy levels of crystal 1402. Monochromator 1406 can be set to transmit 920 nm with a 20 nm band width, corresponding to the lowest wavelength Yb³⁺ absorption band measured and shown in the absorption spectrum shown in FIG. 13. Fluorescence light from crystal 1402 is then passed through a polarizer 1414, which can be a calcite polarizer, and transmitted through an optical fiber 1416 to a spectrograph 1408, which can be an Oriel Instruments spectrograph. A CCD camera 1410, for example an InstaSpec CCD camera, can be coupled to measure the fluorescence from spectrograph 1408. The fluorescence spectrum can be captured by computer 1412 interfacing with camera 1410.

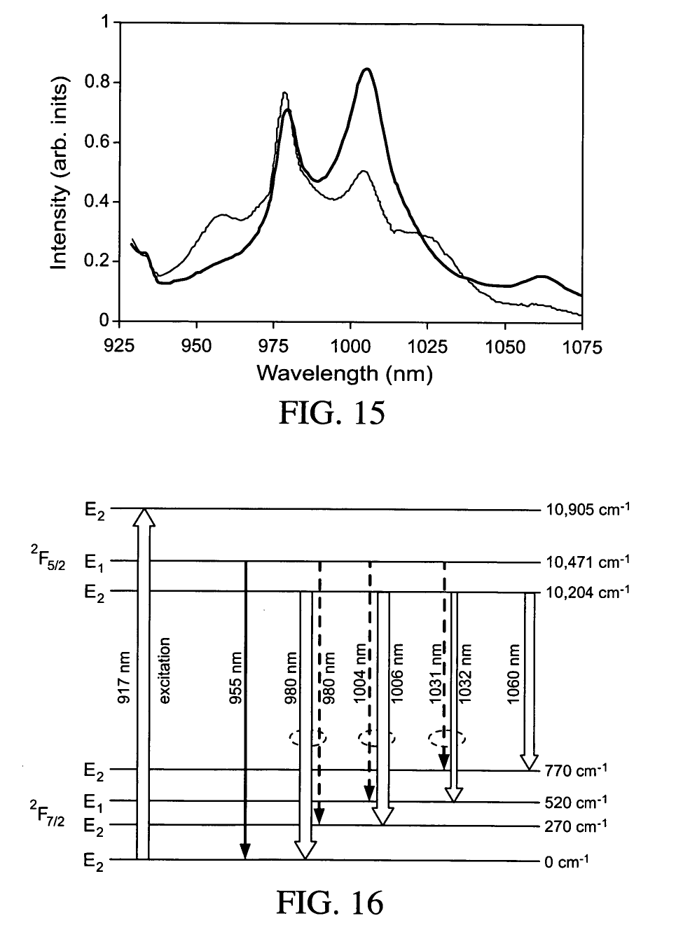

FIG. 15 illustrates polarized fluorescence (optical emission) spectra of Yb:SLN according to the present invention obtained on fluorescence spectrometer 1400. In FIG. 15, the thick gray line represents π polarization (E//z) and the thin black line represents σ polarization (E⊥z). FIG. 16 illustrates the Yb energy levels in SLN. Emission spectra are dominated by transitions from the lowest energy Stark levels of the exited state manifold to the four Stark levels of the ground state manifold. Thus the most prominent emission peaks are 980 nm, 1006 nm, 1032 nm, and 1060 nm. The next most prominent peaks result from the transitions from the next higher energy Stark level of the excited state manifold. Of these transitions only the transition at 955 nm is clearly distinguishable in FIG. 15 as the other three transitions from this level overlap with transitions from the lowest excited state level.

The transitions observed in the emission spectrum of FIG. 15 are depicted graphically in the energy level diagram of FIG. 16. Black transitions represent σ polarized emissions and gray transitions represent π polarized emissions. The thickness of the transition lines represent their relative intensities. Dashed transitions are not observed in the absorption spectrum due to stronger overlapping absorptions. Lines grouped within a dashed circle make up an unresolved emission band.

Once again, higher resolution determination of the ground state energy levels is expected to result from emission spectra obtained at low temperature and/or excitation with 980 nm light which will nearly eliminate population of higher energy Stark levels within the excited state manifold.

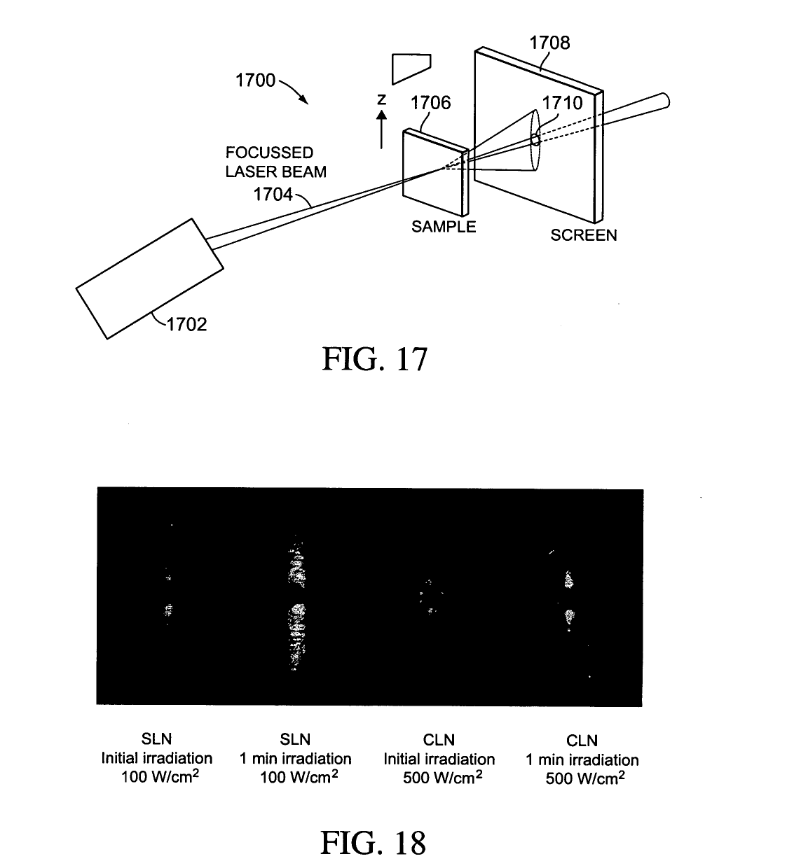

Relative susceptibility to photorefractive damage was also determined on 1 mm-thick slices of CLN, SLN, Mg:SLN, and Yb:SLN. Again, the SLN, Mg:SLN and Yb:SLN samples were produced according to methods described herein. FIG. 17 illustrates an apparatus 1700 for determining photorefractive susceptibility. A beam from a laser 1702, such as a Coherent Innova 400-10 Ar⁺ laser operating in an all lines configuration, can be utilized. In the Ar⁺ laser with all-beams configuration, most of the laser power is concentrated in two laser wavelengths at 488 nm and 514 nm. Beam 1704 from laser 1702 can be focused using, for example, a 50 cm focal length lens to obtain laser fluences as high as 1 kW/cm² at sample crystal 1706. Photorefractive damage can then be detected by visual observation of fanning of the beam after passing through crystal 1706. Beam fanning occurred along the direction corresponding to the z-axis of crystal 1706. Damage was recorded by using a video camera and frame grabber (not shown). Due to the dynamic range of the video camera, the central portion of the transmitted beam (the undistorted beam) was passed through a hole 1710 in screen 1708 so that only the refracted portion of the beam was imaged while the direct portion passed through hole 1710, as is shown in FIG. 18. Acquisition of the video frame required approximately 20 seconds. For each power setting, a series of video frames was acquired starting with initial laser irradiation (0-20 seconds), after 1 minute of laser radiation (60-80 seconds), 2 minutes, 5 minutes and 10 minutes. Laser fluence levels at the sample were estimated to be 100 W/cm², 500 W/cm², and 1000 W/cm².

Video frames of optical damage of undoped SLN at 100 W/cm² and undoped CLN at 500 W/cm² are shown in FIG. 18. At 100 W/cm², photorefractive damage of undoped SLN could be observed during the initial 20 seconds required to acquire the first video image and continue to the point of severe photorefractive damage with one minute exposure. No other samples were observed to exhibit photorefractive damage at 100 W/cm². At 500 W/cm², beam fanning was observed in undoped CLN after 1 minute of laser exposure. Photorefractive damage was not observed in either Yb:SLN or Mg:SLN at any power levels tested here up to 1000 W/cm² and exposure times up to ten minutes. Visual inspection of laser damaged samples revealed index of refraction anomalies that were easily visible with the unaided eye.

Laser induced optical damage in SLN has been the subject of several recent investigations. See Y. Furukawa, K. Kitamura, S. Takekawa, K. Niwa, Y. Yajima, N. Iyi, I. Mnushkina, P. Guggenheim, J. Martin, J. Cryst. Growth 211, 230 (2000); J. Wen, L. Wang, Y. Tang, H. Wang, Appl. Phys. Lett., 53, 260 (1988); Y. Furukawa, M. Sato, K. Kitamura, Y. Yajima, M. Minakata, J. Appl. Phys., 72, 3250 (1992); S. Kan, M. Sakamoto, Y. Okano, D. Yoon, T. Fukuda, 0. Oguri, T. Sasaki, Cryst. Res. Technol., 31, 353 (1996); K. Kitamura, Y. Furukawa, Y. Ji, M. Zgonik, C. Medrano, G. Montemezzani, P. Gunter, J. Appl. Phys. 82, 1006 (1997); Y. Furukawa, K. Kitamura, S. Takekawa, K. Niwa, H. Hatano, Opt. Lett., 23, 1892 (1998); Y. Furukawa, K. Kitamura, S. Takekawa, A. Alexandrovski, R. Route, M. Fejer, G. Foulon, OSA Technical Digest, CLEO 2000, 387 (2000); and L. Huang, D. Hui, D. Bamford, S. Field, I. Mnushkina, L. Meyers, J. Kayser, Appl. Phys. B 72 1 (2001). The reported threshold for optical damage varies widely depending on experimental details such as laser wavelength, exposure format (pulsed versus cw), and detection method (beam fanning, holographic grating efficiency, green induced IR absorption, etc.). However, undoped SLN has generally been observed to have the lowest damage threshold, followed by undoped CLN, then Mg:CLN and finally Mg:SLN. Although Mg:CLN was not evaluated in the experiments described here, the SLN, CLN and Mg: SLN evaluated here followed the same trends as described by other investigators. Particularly noteworthy from these data is the high damage threshold of Yb:SLN similar to Mg:SLN. While undoped SLN is more susceptible to photorefractive damage (lower damage threshold) than undoped CLN, 1% Mg:SLN is less susceptible (higher damage threshold) than 5% Mg:CLN.

A QPM device according to the present invention can be produced by periodic poling of Yb:SLN. Periodically poled frequency conversion devices have been fabricated using CLN, SLN, Mg:CLN, and Mg:SLN. Ferroelectric domain switching is principally characterized by the crystals' spontaneous polarization, magnitude of the electric field required to reorient the spontaneous polarization, and the internal field (difference in field required to flip from positive to negative compared to flipping from negative to positive). These three characteristic quantities are obtained by generating ferroelectric hysteresis loops.

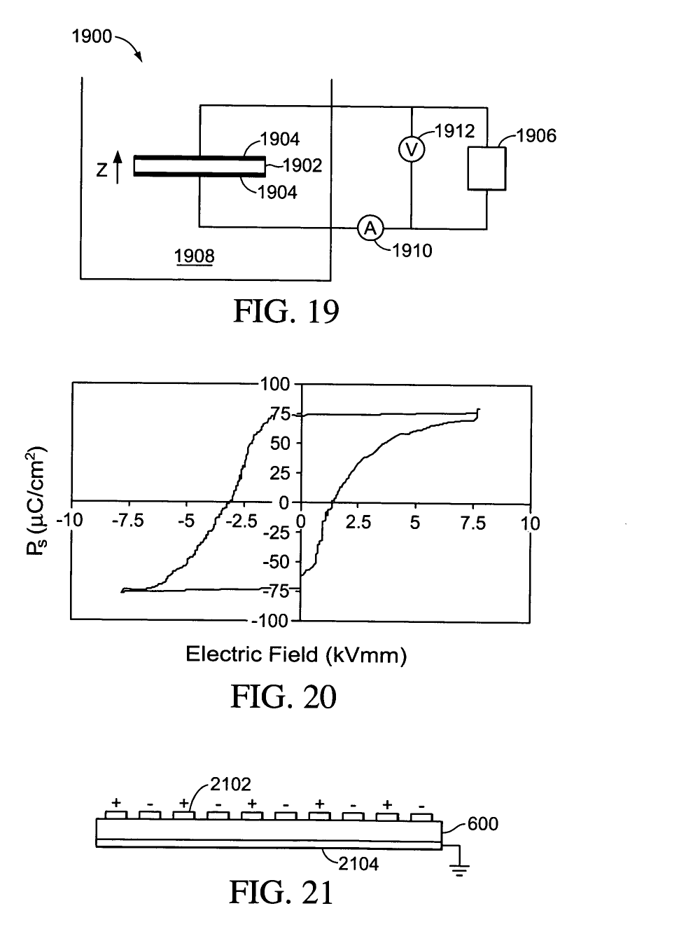

FIG. 19 illustrates an apparatus 1900 for measuring a ferroelectric hysteresis loop for Yb:SLN grown according to embodiments of the present invention. A sample crystal 1902 measuring 12×10×0.52 mm³ was fabricated with z-axis (polar axis) oriented perpendicular to the plate form of the crystal. Poling electrodes 1904 were applied to the z-faces using conductive silver paint. The area under the electrodes was about 0.7 cm². Poling electrodes 1904 can then be connected to a high voltage source 1906, for example using a Kelvin clip, and the crystal and Kelvin clip were submerged in insulating oil 1908 to prevent electrical arcing around the edges of crystal 1902. The applied voltage from voltage source 1906 can be manually controlled using a Lodestar 8210 DC power supply and a Trek model 609D-6 high voltage amplifier. The applied voltage and resulting current were recorded in an ampmeter 1910 and voltmeter 1912. Ampmeter 1910 and voltmeter 1912 can be, for example, formed utilizing a Tektronics model TDS 220 dual channel oscilloscope. The current was then integrated to obtain the charge transferred and resulting spontaneous polarization in sample crystal 1902. Plotting the spontaneous polarization versus applied field then generates the hysteresis loop, an example of which is shown in FIG. 20. The voltage ramp rate (˜200 V/s) can be selected to be as slow as possible to allow for poling to occur and still permit sufficient current to be detected by the oscilloscope. The maximum voltage of 4 kV (8 kV/mm) was maintained for approximately 10 sec to ensure complete poling before ramping the voltage down and reverse poling.

The poling field, spontaneous polarization, and internal field for Yb:SLN are listed in Table 3 along with values reported for CLN and SLN in V. Gopalan, T. Mitchell, Y. Furukawa, K. Kitamura, Appl. Phys. Lett., 72, 1981 (1998), and Mg:SLN in K. Nakamura, J. Kurz, K. Parameswaran, M. Fejer, J. Appl. Phys., 91, 4528 (2002). Ferroelectric hysteresis loops can vary substantially from one measurement to another depending on the experimental details and on the history of the sample. Therefore, the uncertainties in reported poling fields, spontaneous polarization, and internal fields should generally be regarded as large. See L. Huang et al., Appl. Phys. B 72 1; V. Gopalan et al., Appl. Phys. Lett., 72, 1981; and K. Nakamura et al., J. Appl. Phys., 91, 4528. However, while the details of a specific hysteresis experiment can have notable effects on the results, the differences between SLN, CLN and their doped variants are substantial. Results of Yb:SLN ferroelectric hysteresis measured here demonstrate behavior similar to that previously reported for Mg:SLN.

TABLE 3
Ferroelectric Properties of Lithium Niobate

| | CLN | SLN | SLN | Mg:SLN | |
|---|---|---|---|---|---|
| | (*) | (*) | (**) | (**) | Yb:SLN |
| Curie Temp (° C.) | 1139 | 1200 | 1200 | 1205 | 1164 |
| E_{f} (kV/mm) | 21 | 4.8 | 6.6 | 3.5 | 3.0 |
| Eᵣ (kV/mm) | 16 | 4.8 | — | — | 1.4 |
| Eᵢₙₜ (kV/mm) | 2.5 | 0 | — | — | .8 |
| Pₛ (□C/cm²) | 77 | 80 | — | — | 75 |

(*) See V. Gopalan, T. Mitchell, Y. Furukawa, K. Kitamura, Appl. Phys. Lett., 72, 1981 (1998)
(**) See L. Huang, D. Hui, D. Bamford, S. Field, I. Mnushkina, L. Meyers, J. Kayser, Appl. Phys. B 72 1 (2001).

Crystals according to embodiments of the present invention, such as for example the doped single crystal SLN or SLT described herein, can be fabricated into a rod or slab, polished, and coated to form a laser material. Such an arrangement is illustrated by crystal 600 in FIG. 6. When appropriately pumped with a source of radiation at a wavelength within the absorption band of the dopant by pump source 606, the laser material can be used to generate a laser beam at a wavelength in the emission band of the dopant. Lithium niobate and lithium tantalate are both noncentrosymmetric crystals and have non-zero nonlinear optical coefficients. Both crystals are also birefringent and can in principle be used for self-frequency conversion via birefringent phase matching. However, birefringent phase matching is limited to interactions such that some orientation of the polarizations of the initial and resultant beams relative to the crystal exists so that the beams traverse the crystal at the same speed. Since the polarization of the initial wavelength may be fixed or preferred due to anisotropic emission from the active dopant ion, self-frequency conversion via birefringent phase matching is further limited to those interactions with fixed initial polarization. While there may be instances in which such an approach is viable, in general the phase matching requirement described above can severely limit the usefulness of such a crystal for self-frequency conversion.

Alternatively, the technique known as quasi-phase matching (QPM) can be utilized much more easily and with considerable versatility to produce efficient nonlinear frequency conversion of a laser beam in crystals such as lithium niobate and lithium tantalate. Lithium niobate and lithium tantalate are ferroelectric crystals. As such, crystal 600 as formed possesses a spontaneous electric polarization vector which is oriented along the crystallographic c-axis (also denoted as the z-axis) and which can be reversed in direction by applying an electric field along the c-axis that is greater than the coercive field of crystal 600. FIG. 21 illustrates a crystal 600 being poled by alternating polarity strips of electrodes 2102. Electrodes 2102 can be proximate or mounted to crystal 600 opposite a ground electrode 2104. When the orientation of the spontaneous polarization is uniform throughout crystal 600 it is said to be single domain. A pattern of alternating domains can be fabricated starting with a single domain crystal and then applying an electric field greater than the coercive field via a patterned electrode 2102 on either of the faces of the crystal, thereby reversing the orientation of the spontaneous polarization in the volume of the crystal that lies beneath the patterned electrode.

Alternating the orientation of the ferroelectric domains in the poled crystal 600 has the effect of changing the sign of the NLO coefficient. If the orientation of the domains is inverted at an interval equivalent to the distance required for the relative phase of the initial and resultant laser beams to change by π, energy will always flow in one direction (from initial to resultant beam). Given a laser beam at an initial wavelength, the resultant wavelength is determined by the periodicity of the ferroelectric domain structure. In contrast to birefringent phase matching (BPM), QPM allows for efficient frequency conversion for any interaction within the transparency range of the crystal. In addition, the periodic structure can be designed to make use of the highest nonlinear optical coefficients of the crystal thereby significantly increasing conversion efficiency. Another significant advantage to QPM is that the phase matching condition is typically less sensitive to spectral and temperature variations than it is for BPM. For example, PPLN generating the second harmonic of 1 μm laser radiation has a spectral bandwidth 4 times greater and temperature bandwidth 3 times greater than traditional birefringently phase matched lithium niobate. The spectral and temperature bandwidth can be further increased by intentionally “blurring” the domain period. Greater spectral and temperature bandwidths dramatically reduce many of the previously discussed instabilities inherent in traditional intracavity frequency conversion which have limited practical self-frequency conversion lasers in the past.

An advantage of SLN and SLT as compared to CLN and CLT is the significantly lower coercive field measured for the stoichiometric crystals. The coercive field of CLN and CLT is reported to be approximately 22 kV/mm while the coercive field is approximately 4 kV/mm for SLN and 2 kV/mm for SLT. The coercive field for Yb-doped SLN grown according to the present invention has been measured to be approximately 3 kV/mm, as is shown in Table 3 above.

Although other techniques are also available for producing similar periodically varying domain structures, the versatility and ease of fabrication made possible by use of the electric-field poling method illustrated in FIG. 21 to produce QPM devices according to the present invention is a significant advantage over other methods. In previous studies of Yb:CLN and Yb,Mg:CLN, see J. Capmany et al., Appl. Phys. Lett. 74, 1534 and J. Capmany et al., Appl. Phys. Lett. 76, 1374, the QPM structure was produced during crystal growth by displacing the crystal growth axis from the symmetry axis of the temperature field. This results in a periodic temperature fluctuation of the growth interface as the crystal rotates and produces a QPM period that is fixed by the rotation rate and pulling rate of the growing crystal. Although lasing and self-frequency doubling were reported, the QPM structures produced during growth were noted to be inhomogeneous over large areas, and the maximum reasonably homogenous device that could be fabricated had an interaction length of less than 3 mm. The maximum calculated d_{eff} in these cases was less than ⅓ the theoretical d_{eff}, providing further indication of inhomogeneous QPM. Wide variation in the QPM period is to be expected when producing QPM structures in this fashion as the complex interdependence of many factors affecting crystal growth makes it extremely difficult to precisely control the period of the induced fluctuation over the time required to grow several millimeters. In addition to higher quality periodic domain structures, QPM structures fabricated via electric field poling have the advantages of being more versatile in allowing many different structures to be produced in a single crystal and allowing for asymmetric or multiple-period structures to be fabricated in a single device for complex and cascaded NLO interactions. Periodic poling of CLN and CLT using the electric-field poling method is possible; however, the much lower coercive fields found in crystals of SLN and SLT, and which has been demonstrated by the inventors for Yb-doped SLN, make the stoichiometric crystals highly advantageous for fabrication of QPM devices as compared with crystals of the congruent composition.

Some embodiments of the present invention include a periodically-poled crystal of ytterbium-doped stoichiometric lithium niobate or stoichiometric lithium tantalate. The dopant concentration should be in the range of approximately 0.2 to 2.0 atomic %. Ytterbium displays absorption and emission bands in the range of approximately 917 to 1060 nm. A particularly useful absorption feature is found near 980 nm, which is readily pumped by radiation from commercially available laser diodes and results in promotion of electrons from the lowest-lying Stark level of the ²F_{7/2} ground state to the lowest-lying Stark level of the ²F_{5/2} excited state. Emission bands near 1030 nm and 1060 nm represent transitions from the lowest-lying Stark level of the excited state to the upper-lying Stark levels of the ground state and are preferred for laser output. Second harmonic generation from the fundamental beam at 1060 nm will produce a frequency-doubled output beam at 530 nm. In order to accomplish this via quasi-phase matching, a periodically poled structure is fabricated via an electrical domain-inversion process in an initially single-domain crystal volume. The resulting periodically-poled Yb:SLN or Yb:SLT sample is cut to a desired length, depending on the absorption properties of the crystal, its ends are polished and coated with appropriate anti-reflecting and/or partially-reflecting coatings and when placed in an optical cavity with a suitable source of pump radiation, for example an InGaAs laser diode, will generate an output laser beam of excellent beam quality at the second harmonic wavelength near 530 nm. QPM structures with other periods and more complex configurations can also be fabricated, enabling output of frequency-converted light at a variety of wavelengths.

As another example of a stoichiometric lithium niobate crystal isomorph host material doped with at least one laser ion, a crystal of ytterbium-doped stoichiometric lithium tantalate was grown by the top-seeded solution growth method in apparatus 714 where heaters 716 are RF induction-type heaters. Melt 704 was arranged with a composition corresponding to a ratio of 60 mol % Li₂O to 40 mol % Ta₂O₅. Melt 704 was prepared from starting materials consisting of high-purity (≧99.999%) powders of Ta₂O₅ and Li₂CO₃. Dopant was added as Yb₂O₃ powder (99.998% purity) to provide a concentration of 0.5 mol % in the melt. The powders of these materials were weighed out and mixed together and then added to a platinum crucible 702 in which they were melted. Several steps of adding the Li₂CO₃+Ta₂O₅ mixture, melting, and recharging were required to fill crucible 702. Crucible 702 was cylindrical and measured 75 mm in diameter and 75 mm in height. The wall thickness of crucible 702 was 2 mm. The crucible was placed within an alumina tube of approximately 100 mm I.D.×75 mm height, and the space between the crucible and tube was packed with alumina bubble to support the crucible and reduce the heat loss during crystal growth. A second alumina tube of approximately 80 mm and 200 mm height was placed above the crucible, and an outer tube of mullite, approximately 190 mm I.D×300 mm in length surrounded the crucible support. Between the inner and outer tubes, alumina bubble-type insulation was arranged in order to reduce heat losses during crystal growth. The weight of melt 704 was approximately 1100 g.

The furnace 714 where SLT crystal growth was conducted was an RF induction-heated furnace, with power delivered by a 25 kW, 30 kHz RF generator radiating through a water-cooled copper coil 716 approximately 230 mm diameter×180 mm high. Platinum crucible 702 was placed inside the RF coil 716 of furnace 714, such that the radiant energy from the RF coil 716 was absorbed by the platinum crucible 702 causing it to attain temperatures of 1550-1600° C. and thereby melting the powders placed into the crucible 702 and form the melt 704.

Growth of resulting crystal 712 was initiated on a seed 706 of congruent LiTaO₃. Rod 708 included a Pt seed holder for holding seed 706 attached to an alumina tube (pull rod). Seed crystal 706 measured 6.3 mm in diameter and 20 mm long. The vertical axis of seed 706 was the z-direction (or c-axis) of the LiTaO₃ crystal.

A load cell (not shown) can be used to monitor the weight of resulting crystal 712 during growth. Seed 706 was suspended from a rod 708 that includes a platinum fixture at the end of the alumina rod. The alumina rod can be held by a centering chuck (not shown) beneath the load cell (not shown), which in turn was attached to rotation/translation mechanisms 708 and 710. Growth was initiated by dipping seed 706 into melt 704 and partially melting back the end of seed 706. During growth, seed 706 was rotated at about 4-5 rpm and pulled at about 0.2-0.3 mm/h. The temperature of furnace 714, initially near 1555° C., was lowered at a rate of 0.1°/h, over a temperature interval of 20 degrees, after which resulting crystal 712 was withdrawn from the melt and slowly cooled to room temperature. The growth run took approximately 5 days for growth followed by 3 days to cool the crystal to room temperature.

The weight of resulting SLT crystal 712 grown as described above was 115 g. The crystal reached a maximum diameter of about 30 mm and a length of about 35 mm. FIGS. 8E and 8F show top and side views of the resulting crystal 712 of Yb-doped SLT crystal grown according to the methods described here.

The examples and discussions of test data presented herein is exemplary only and is not intended to be limiting. Furthermore, explanations provided for observed data measured on crystals according to embodiments of the present invention are not intended to be limiting in any way. As such, the invention is limited only by the following claims.

1. A laser crystal, comprising a stoichiometric lithium niobate crystal isomorph host material doped with at least one laser ion.

2. The crystal of claim 1, wherein the stoichiometric lithium niobate crystal isomorph host material is lithium niobate.

3. The crystal of claim 1, wherein the stoichiometric lithium niobate crystal isomorph host material is lithium tantalate.

4. The crystal of claim 1, wherein the at least one laser ion includes Ytterbium.

5. The crystal of claim 1, wherein the at least one laser ion includes a rare-earth ion.

6. The crystal of claim 1, wherein the stoichiometric lithium niobate crystal isomorph host material is periodically poled.

7. The crystal of claim 1, further including an additional dopant ion.

8. The crystal of claim 7, wherein the additional dopant ion is magnesium.

9. A laser, comprising:
a laser cavity including opposing mirrors, at least one of the opposing mirrors allowing passage of a portion of a light beam;
a stoichiometric lithium niobate crystal isomorph host material doped with at least one laser ion positioned in the laser cavity; and
a pump source that produces excitation for at least one of the at least one laser ions.

10. The laser of claim 9, wherein the stoichiometric lithium niobate crystal isomorph host material is lithium niobate.

11. The laser of claim 9, wherein the stoichiometric lithium niobate crystal isomorph host material is lithium tantalate.

12. The laser of claim 9, wherein the at least one laser ion includes Ytterbium.

13. The laser of claim 9, wherein the at least one laser ion includes a rare-earth ion.

14. The laser of claim 9, wherein the stoichiometric lithium based niobate crystal isomorph host material is periodically poled.

15. The laser of claim 9, further including an additional dopant ion.

16. The laser of claim 15, wherein the additional dopant ion is Magnesium.

17. A method of forming a laser crystal, comprising:
mixing constituent powders to form a mixture;
melting the mixture to form a laser-ion doped lithium rich melt;
placing a seed crystal into the melt;
rotating the seed crystal at a rotation rate and pulling the seed crystal from the melt at a pull rate while lowering the temperature at a temperature cooling rate to grow the resulting crystal; and
cooling the resulting crystal,
wherein the resulting crystal is a stoichiometric lithium niobate crystal isomorph doped with the laser ion.

18. The method of claim 17, wherein the constituent powders include 58 mol % Li₂O, 42 mol % Nb₂O₃, and Yb₂O₃.

19. The method of claim 18, wherein the laser-ion doped lithium rich melt includes about 1% Yb doping.

20. The method of claim 17, wherein the seed crystal is lithium niobate.

21. The method of claim 17, wherein the initial temperature of a furnace while melting the mixture is about 1200° C.

22. The method of claim 21, wherein the rotation rate is about 2 to about 3 rpm.

23. The method of claim 21, wherein the pull rate is about 0.1 to about 0.2 mm/hr.

24. The method of claim 21, wherein the temperature cooling rate is about 0.05 to about 0.2° C./hr.

25. The method of claim 17, wherein the constituent powders include a lithium oxide and a tantalum oxide.

26. The method of claim 17, further including periodically poling the stoichiometric lithium niobate crystal isomorph.

27. The method of claim 26, wherein periodically poling the stoichiometric lithium niobate crystal isomorph includes applying alternating electric fields across the crystal.

28. The method of claim 17, wherein the rotation rate is between about 2 and about 30 rpm, the puling rate is between about 0.1 to about 2 mm/h, and the cooling rates is in the range of about 0.05 to about 0.5° C./h.
